(19) United States
(12) Patent Application Publication
(10) Pub. No.: US 2014/0321532 A1
(43) Pub. Date: Oct. 30, 2014

(54) TECHNIQUES FOR COORDINATING PARALLEL VIDEO TRANSCODING

(71) Applicants: DEVADUTTA GHAT, Sunnyvale, CA (US); AMIT PUNTAMBEKAR, Fremont, CA (US); HIMANI D. TIDKE, Santa Clara, CA (US); VINUTHA RUMALE, Santa Clara, CA (US)

(72) Inventors: DEVADUTTA GHAT, Sunnyvale, CA (US); AMIT PUNTAMBEKAR, Fremont, CA (US); HIMANI D. TIDKE, Santa Clara, CA (US); VINUTHA RUMALE, Santa Clara, CA (US)

(21) Appl. No.: 13/871,478

(22) Filed: Apr. 26, 2013

(51) Int. Cl. H04N 19/40; H04N 19/124; H04N 19/115

(52) U.S. Cl. CPC H04N 19/00472; H04N 19/0006; H04N 19/0009
USPC 375/240.03; 375/240.02

(57) ABSTRACT

Various embodiments are generally directed to techniques to coordinate control of bitrates among multiple computing devices employed in parallel to transcode portions of a motion video. A device to coordinate parallel video transcoding includes a processor component; and a monitoring component for execution by the processor component to determine whether a total current bitrate remains within a target range of bitrates to transcode multiple segments of an original video data using multiple slave devices in parallel to generate a transcoded video data, the total current bitrate comprising a sum of current bitrates of video compression performed by the multiple slave devices in transcoding the multiple segments. Other embodiments are described and claimed.

### TECHNICAL FIELD

Embodiments described herein generally relate to coordinating the parallel transcoding of segments of a motion video by multiple computing devices.

### BACKGROUND

Motion video is typically compressed using a “coder-decoder” (codec) employing one of several widely accepted video compression algorithms in which the resulting bitrate of the motion video varies from one portion to another. By way of example, in a portion of a typical motion video program in which the credits are presented, the typical black background with slowly scrolling white text characters is able to be encoded with a relatively low bitrate due to the relatively low complexity of imagery and movement therein. In contrast, a fast-moving action scene with multiple complexly shaped and/or colored objects moving in various directions requires encoding with a relatively high bitrate to preserve sufficient detail to avoid a viewer noticing visual artifacts such as pixelation or blurring.

The vast majority of motion videos include a mixture of portions with relatively low and relatively high complexity of imagery and movement resulting in wide variations in bitrate requirements. As a result, it is usually prohibitively difficult to determine the final data size of a motion video in compressed form with reasonable accuracy without actually compressing it. Due to this difficulty, in video streaming services, there is usually a data size “budget” allocated to each motion video that is usually specified in terms of a target range of data size for that motion video to fit within following compression. Such a range is typically selected to specify a data size large enough to permit a high enough average bitrate across the entirety of a motion video to enable compression that preserves sufficient detail to minimize the introduction of visual artifacts while also restricting the data size to a practical maximum to avoid the expense and difficulties of storing and streaming unnecessarily large data.

In compressing motion video, one or more quantization parameters (depending on the specification with which the codec complies) are selected to control aspects of the encoding algorithm used in the compression process to attempt to reach an average bitrate over the entirety of the motion video in its compressed form that fits within the selected target range of data size. It may be that as compression is carried out, an analysis is made of the changing bitrate to determine if the one or more quantization parameters should be modified to better ensure that the resulting data size of the compressed motion video will be within the selected target range. The difficulties in controlling one or more quantization parameters to achieve a data size within a target range when compressing a motion video on a single computing device are already substantial. Those difficulties are exacerbated when compressing a motion video using multiple computing devices in parallel.

### BRIEF DESCRIPTION OF THE DRAWINGS

FIG. 1 illustrates an embodiment of a video transcoding system.

FIGS. 2-4 each illustrate a phase of operation of an embodiment.

FIGS. 5-6 each illustrate a portion of an embodiment.

FIGS. 7-9 each illustrate aspects of coordinating parallel video transcoding in an embodiment.

FIGS. 10-11 each illustrate a logic flow according to an embodiment.

FIG. 12 illustrates a processing architecture according to an embodiment.

FIG. 13 illustrates alternate embodiment of a video transcoding system.

FIG. 14 illustrates an embodiment of a device.

### DETAILED DESCRIPTION

Various embodiments are generally directed to techniques to coordinate control of bitrates among multiple computing devices employed in parallel to transcode portions of a motion video. More specifically, a motion video is divided into segments within a master device and those segments are distributed among multiple slave devices along with various settings to be employed by each of the slave devices in transcoding. Operating substantially in parallel, the slave devices transcode their respective segments employing the settings provided to each, and recurringly signaling the master device with indications of the bitrates each currently requires in transcoding their respective segments.

The master device monitors the parallel transcoding of each of the segments through the recurring signaling of indications of current bitrates from the slave devices, and recurringly sums their current bitrates to derive a current total bitrate therefrom. The master device recurringly compares the current total bitrate to a target bitrate and/or a target range of bitrates selected to enable the motion video to achieve a data size that is either relatively close to a target data size or is within a target range of data sizes when the compression portion of its transcoding is complete.

Where a total current bitrate is simply to remain within a target range of bitrates, variations in the current bitrate among the slave devices are permitted by the master device as long as the total current bitrate remains within the target range. However, where a total current bitrate is to remain relatively close to a specified target bitrate, the master device may recurringly transmit adjusted values for one or more main quantization parameters employed by the slave devices for video compression to dynamically adjust the current bitrates of each of the slave devices to keep the total current bitrate relatively close to that target bitrate. Where there is such a specified target bitrate, a target range of bitrates may be derived by the master device to provide an upper and/or a lower limit for the total current bitrate beyond which the master device may take further action.

Regardless of whether there is a specified target bitrate, in response to instances in which the total current bitrate ceases to be within the target range, the master device may signal one or more of the slave devices to cease using a main quantization parameter and switch to using an alternate quantization parameter selected to cause a significant change in current bitrate in one or more of the slave devices to bring the total current bitrate back within the target range. By way of example, where the total current bitrate rises sharply or above the maximum bitrate of the target range of bitrates, the master device may signal one or more of the slave devices to enter a panic mode in which one or more alternate quantization parameters are used to cause a significant decrease in one or more of the current bitrates. Further, one or more of the slave devices may be caused to signal their current bitrates to the master device more frequently.

With general reference to notations and nomenclature used herein, portions of the detailed description which follows may be presented in terms of program procedures executed on a computer or network of computers. These procedural descriptions and representations are used by those skilled in the art to most effectively convey the substance of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include general purpose digital computers as selectively activated or configured by a computer program stored within that is written in accordance with the teachings herein, and/or include apparatus specially constructed for the required purpose. Various embodiments also relate to apparatus or systems for performing these operations. These apparatus may be specially constructed for the required purpose or may include a general purpose computer. The required structure for a variety of these machines will appear from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives within the scope of the claims.

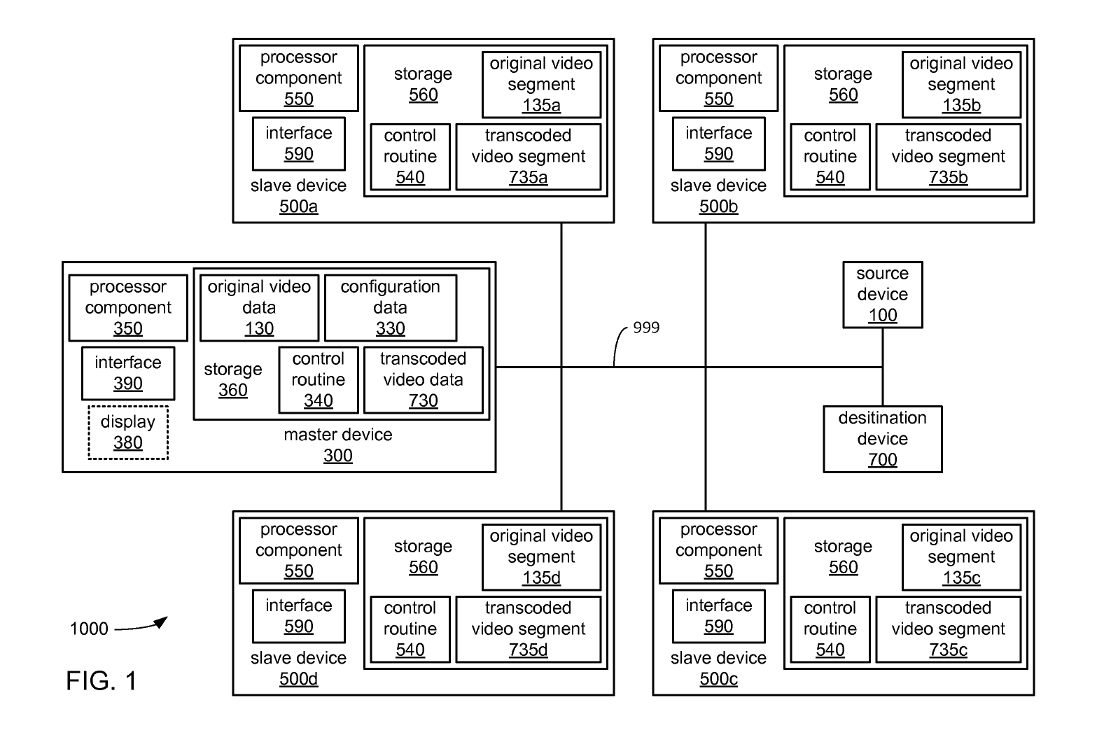

FIG. 1 is a block diagram of an embodiment of a video transcoding system 1000 incorporating one or more of a source device 100, a master device 300, one or more slave devices 500a-d, and a destination device 700. Each of these computing devices may be any of a variety of types of computing device, including without limitation, a desktop computer system, a data entry terminal, a laptop computer, a netbook computer, a tablet computer, a handheld personal data assistant, a smartphone, a digital camera, a body-worn computing device incorporated into clothing, a computing device integrated into a vehicle (e.g., a car, a bicycle, a wheelchair, etc.), a server, a cluster of servers, a server farm, etc.

As depicted, these computing devices 100, 300, 500a-d and 700 exchange signals conveying video data, as well as settings, parameters and/or status related to coordinating parallel operation to transcode motion video through a network 999. However, one or more of these computing devices may exchange other data entirely unrelated to motion video and/or the transcoding of motion video with each other and/or with still other computing devices (not shown) via the network 999. In various embodiments, the network may be a single network possibly limited to extending within a single building or other relatively limited area, a combination of connected networks possibly extending a considerable distance, and/or may include the Internet. Thus, the network 999 may be based on any of a variety (or combination) of communications technologies by which signals may be exchanged, including without limitation, wired technologies employing electrically and/or optically conductive cabling, and wireless technologies employing infrared, radio frequency or other forms of wireless transmission.

In various embodiments, the master device 300 incorporates one or more of a processor component 350, a storage 360, a display 380 and an interface 390 to couple the master device 300 to the network 999. The storage 360 stores one or more of a control routine 340, a configuration data 330, an original video data 130 and a transcoded video data 730. In various embodiments, each of the slave devices 500a-d incorporates one or more of a processor component 550, a storage 560 and an interface 590 to couple corresponding ones of the slave devices 500a-d to the network 999. The storage 560 stores one or more of a control routine 540, and corresponding ones of original video segments 135a-d and transcoded video segments 735a-d.

The control routine 340 incorporates a sequence of instructions operative on the processor component 350 in its role as a main processor component of the master device 300 to implement logic to perform various functions. In executing the control routine 340, the processor component 350 receives the original video data 130 to be transcoded to generate the transcoded video data 730 therefrom, and receives the configuration data 330 specifying one or more aspects of that transcoding. These may be received either from the source device 100 via the network 999, or may be received in some other way (e.g., conveyed to the master device 300 via a removable storage medium, not shown) and/or from some other source.

The original video data 130 comprises a digitally encoded motion video, including and not limited to, a home video, a documentary video, an episode of a television program, a movie, etc. As will be explained in greater detail, the processor component 350 divides the original video data 130 into the original video segments 135a-d, each of substantially similar data size. The quantity of the original video segments 135a-d is selected to be equal to the quantity of slave devices to be used in transcoding those segments. As depicted, the quantity of slave devices is four, namely the slave devices 500a-d such that the quantity of the original video segments 135a-d is also four. However, this depicted quantity of four slave devices and corresponding four video segments is but an example, and other quantities of slave devices and video segments may be associated with other possible embodiments.

The processor component 350 then transmits one each of the original video segments 135a-d to corresponding ones of the slave devices 500a-d to be transcoded by each substantially in parallel. As those skilled in the art of motion video processing will readily recognize, the term “transcoding” may denote any of a number of video processing operations or combinations of video processing operations, including and not limited to compression (also referred to as “encoding”), decompression (also referred to as “decoding”), resealing, conversion between compression formats, insertion of overlay text, combining with an image or other motion video, etc. Given that digitally encoded motion video (e.g., the motion video of the video data 130) tends to be stored and transmitted in a compressed form, transcoding typically includes at least decompression to enable other video processing followed by recompression. It should be noted that it is assumed herein that the transcoding of the original video data 130 into the transcoded video data 730 includes at least compression in generating the transcoded video data 730, regardless of whatever other video processing may also be included.

The processor component 350 also transmits one or more settings to each of the slave devices 500a-d to control at least some aspects of the transcoding of the original video segments 135a-d, respectively, performed by each, including one or more initial values for main quantization parameter(s) to be used in performing compression. Those skilled in the art of video compression will readily recognize that various ones of the more widely used and accepted algorithms for video compression (e.g., MPEG, H264, AVC, etc.) are lossy algorithms in which one or more quantization parameters are used to control the degree of compression, and accordingly, the degree of loss of video information. Lossy compression algorithms for compressing any type of data, unlike lossless compression algorithms, actually cause a degree of loss of information in performing compression. Such parameters used in lossy compression as quantization parameters are selected to balance achieving a relatively high compression ratio with avoiding the loss of too much information. In the field of motion video compression, one or more quantization parameters (depending on the compression algorithm chosen, there may be one or more than one) are selected to balance achieving a relatively high compression ratio with avoiding the introduction of noticeable visual artifacts (e.g., pixelation or blurring). The compression ratio is related to the resulting bitrate inasmuch as a greater compression ratio results in a smaller bitrate, and like the bitrate, the compression ratio is difficult to ascertain with reasonable accuracy in advance of actually performing compression.

The configuration data 330 may specify a target average bitrate, a target range of average bitrates, a target data size and/or a target range of data sizes for the transcoded video data 730 to achieve upon being generated from the original video data 130. As has been discussed, due to the difficulty in determining what the average bitrate or data size of a motion video will be following its compression, the average bitrate and/or data size that may be specified as a target range. However, it may be that a specific target bitrate or target data size may also be specified that represents an overall average bitrate or data size that is sought to be reached relatively closely by the transcoded video data 730.

Where a target data size or a target range of data sizes is specified in the configuration data 330 in lieu of specifying a bitrate, the processor component 350 may calculate the target bitrate or target range of bitrates from an initial analysis of the original video data 130 and whatever target data size or target range of data sizes is specified. Also, the configuration data 330 may include an indication of what forms of video processing are to be included in the transcoding of the original video data 130 into the transcoded video data 730. From at least the information provided in the configuration data 330, the processor component 350 derives at least some of the settings transmitted to each of the slave devices 500a-d, including the one or more initial values for main quantization parameters to be used in a compression portion of the transcoding to be done.

Also, where no target range of bitrates or data size is specified, the processor component 350 derives a target range of bitrates. In some embodiments where a target range of bitrates is to be so derived, various default parameters may be used to select that minimum and/or maximum bitrate, including and not limited to, a percent deviation, one or more multipliers, etc. In one possible embodiment, the maximum bitrate of the target range may be selected to be twice the specified target bitrate and the minimum bitrate of the target range may be selected to be one quarter of the specified target bitrate.

The control routine 540 incorporates a sequence of instructions operative on the processor component 550 in its role as a main processor component in each of the slave devices 500a-d to implement logic to perform various functions. In executing the control routine 540, the processor component 550 of each of the slave devices 500a-d receives a corresponding one of the original video segments 135a-d and initial settings from the master device 300. The processor components 550 of each of the slave devices 500a-d then transcode their respective ones of the original video segments 135a-d substantially in parallel, thereby generating corresponding ones of the transcoded video segments 735a-d. During the transcoding of their respective ones of the original video segment 135a-d, each of the processor components 550 recurringly transmit indications of their current bitrate in the compression portion of their transcoding to the master device 300 via the network 999. Also during this transcoding, each of the processor components 550 also awaits signals indicating a change to a main quantization parameter or an instruction to switch between main and alternate quantization parameters from the master device 300 via the network 999, and each implements such changes as each of the processor components 550 continues transcoding.

The processor component 350 receives the indications of current bitrate from each of the slave devices 500a-d, and recurringly derives a current total bitrate from these indications. The processor component 350 also recurringly compares the current total bitrate to the target range of bitrates to determine if the current total bitrate falls within that range. As has been discussed, in some embodiments, the processor component 350 permits variations in the current bitrates among the slave devices without taking action to adjust one or more main quantization parameters as long as the total current bitrate remains within the target range. Stated differently, the processor component 350 allows fluctuations in the current bitrates among the slave devices 500a-d where one current bitrate may increase while another current bitrate decreases such that there is a “trading off” among these current bitrates as long as the total of these bitrates at any given time is within the target range of bitrates.

However, in other embodiments, the processor component 350 recurringly compares the current total bitrate to a single specified target bitrate and recurringly transmits adjusted values for main quantization parameters to the slave devices 500a-d in an effort to alter their current bitrates to keep the total current bitrate relatively close to that target bitrate. Specifically, the processor component 350 may recurringly transmit adjusted values for main quantization parameters to one or more of the slave devices 500a-d to counteract instances in which the total current bitrate is diverging away from the target bitrate. In such embodiments, the processor component 350 may recurringly analyze current trends in the rise and fall of the current bitrates of each of the slave devices 500a-d to determine what adjustments to make to the main quantization parameters employed by each of them to maintain the total current bitrate relatively close to the target bitrate. Stated differently, the processor component 350 may recurringly derive projections of instances where the current total bitrate may be about to diverge from the target bitrate.

Where the current total bit rate ceases to be within the target range, the processor component 350 may signal one or more of the slave devices 500a-d to enter a panic mode in which use of a main quantization parameter is supplanted with use of an alternate quantization parameter to cause a significant change in current bitrate. Further, in such a panic mode, the slave devices 500a-d are caused to signal their current bitrates more frequently to enable the master device 300 to track their current bitrates with greater accuracy.

Upon completion of the transcoding of each of their respective ones of the original video segments 135a, the processor components 550 of each of the slave devices 500a-d transmit their respective ones of the now generated transcoded video segments 735a-d to the master device 300 via the network 999. The processor component 350 receives the transcoded video segments 735a-d and assembles them into the transcoded video data 730. The processor component 350 may then visually present the transcoded video data 730 on the display 380. Alternatively or additionally, the processor component 350 may operate the interface 390 to transmit the transcoded video data 730 to the destination device 700. It should be noted that although separate devices are depicted as providing the original video data 130 to the master device 130 and as receiving the transcoded video data 730, in other possible embodiments, these two devices may be one and the same.

In various embodiments, each of the processor components 350 and 550 may include any of a wide variety of commercially available processors. Further, one or more of these processor components may include multiple processors, a multi-threaded processor, a multi-core processor (whether the multiple cores coexist on the same or separate dies), and/or a multi-processor architecture of some other variety by which multiple physically separate processors are in some way linked.

In various embodiments, each of the storages 360 and 560 may be based on any of a wide variety of information storage technologies, possibly including volatile technologies requiring the uninterrupted provision of electric power, and possibly including technologies entailing the use of machine-readable storage media that may or may not be removable. Thus, each of these storages may include any of a wide variety of types (or combination of types) of storage device, including without limitation, read-only memory (ROM), random-access memory (RAM), dynamic RAM (DRAM), Double-Data-Rate DRAM (DDR-DRAM), synchronous DRAM (SDRAM), static RAM (SRAM), programmable ROM (PROM), erasable programmable ROM (EPROM), electrically erasable programmable ROM (EEPROM), flash memory, polymer memory (e.g., ferroelectric polymer memory), ovonic memory, phase change or ferroelectric memory, silicon-oxide-nitride-oxide-silicon (SONOS) memory, magnetic or optical cards, one or more individual ferromagnetic disk drives, or a plurality of storage devices organized into one or more arrays (e.g., multiple ferromagnetic disk drives organized into a Redundant Array of Independent Disks array, or RAID array). It should be noted that although each of these storages is depicted as a single block, one or more of these may include multiple storage devices that may be based on differing storage technologies. Thus, for example, one or more of each of these depicted storages may represent a combination of an optical drive or flash memory card reader by which programs and/or data may be stored and conveyed on some form of machine-readable storage media, a ferromagnetic disk drive to store programs and/or data locally for a relatively extended period, and one or more volatile solid state memory devices enabling relatively quick access to programs and/or data (e.g., SRAM or DRAM). It should also be noted that each of these storages may be made up of multiple storage components based on identical storage technology, but which may be maintained separately as a result of specialization in use (e.g., some DRAM devices employed as a main storage while other DRAM devices employed as a distinct frame buffer of a graphics controller).

In various embodiments, the interfaces 390 and 590 may employ any of a wide variety of signaling technologies enabling computing devices to be coupled to other devices as has been described. Each of these interfaces includes circuitry providing at least some of the requisite functionality to enable such coupling. However, each of these interfaces may also be at least partially implemented with sequences of instructions executed by corresponding ones of the processor components (e.g., to implement a protocol stack or other features). Where electrically and/or optically conductive cabling is employed, these interfaces may employ signaling and/or protocols conforming to any of a variety of industry standards, including without limitation, RS-232C, RS-422, USB, Ethernet (IEEE-802.3) or IEEE-1394. Where the use of wireless signal transmission is entailed, these interfaces may employ signaling and/or protocols conforming to any of a variety of industry standards, including without limitation, IEEE 802.11a, 802.11b, 802.11g, 802.16, 802.20 (commonly referred to as “Mobile Broadband Wireless Access”); Bluetooth; ZigBee; or a cellular radiotelephone service such as GSM with General Packet Radio Service (GSM/GPRS), CDMA/1xRTT, Enhanced Data Rates for Global Evolution (EDGE), Evolution Data Only/Optimized (EV-DO), Evolution For Data and Voice (EV-DV), High Speed Downlink Packet Access (HSDPA), High Speed Uplink Packet Access (HSUPA), 4G LTE, etc.

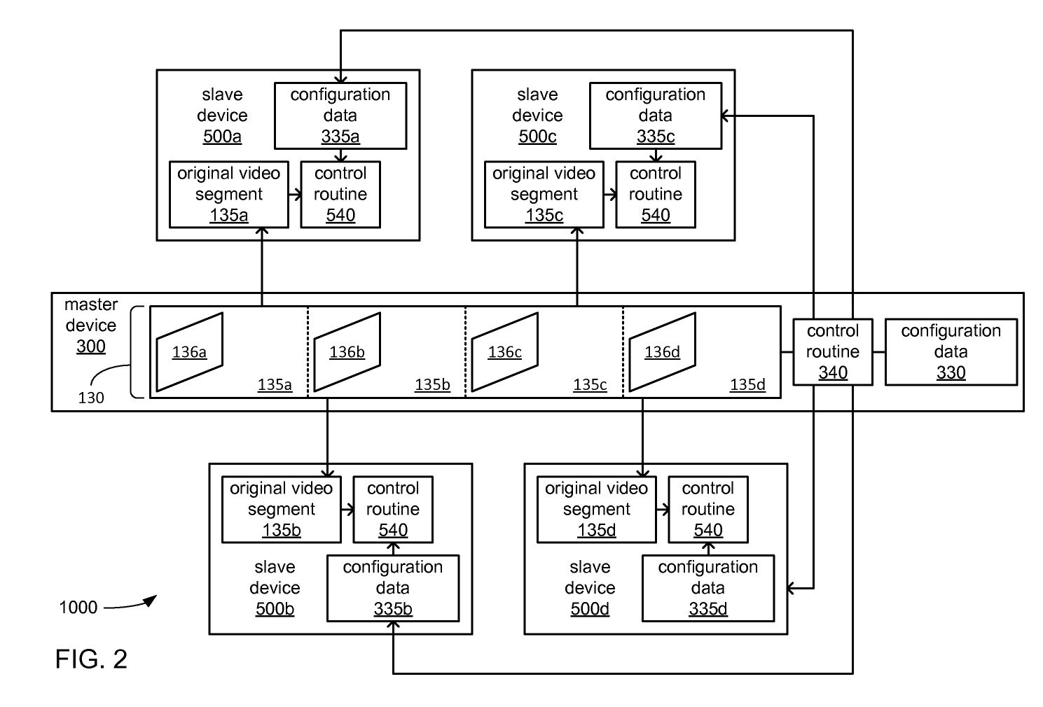

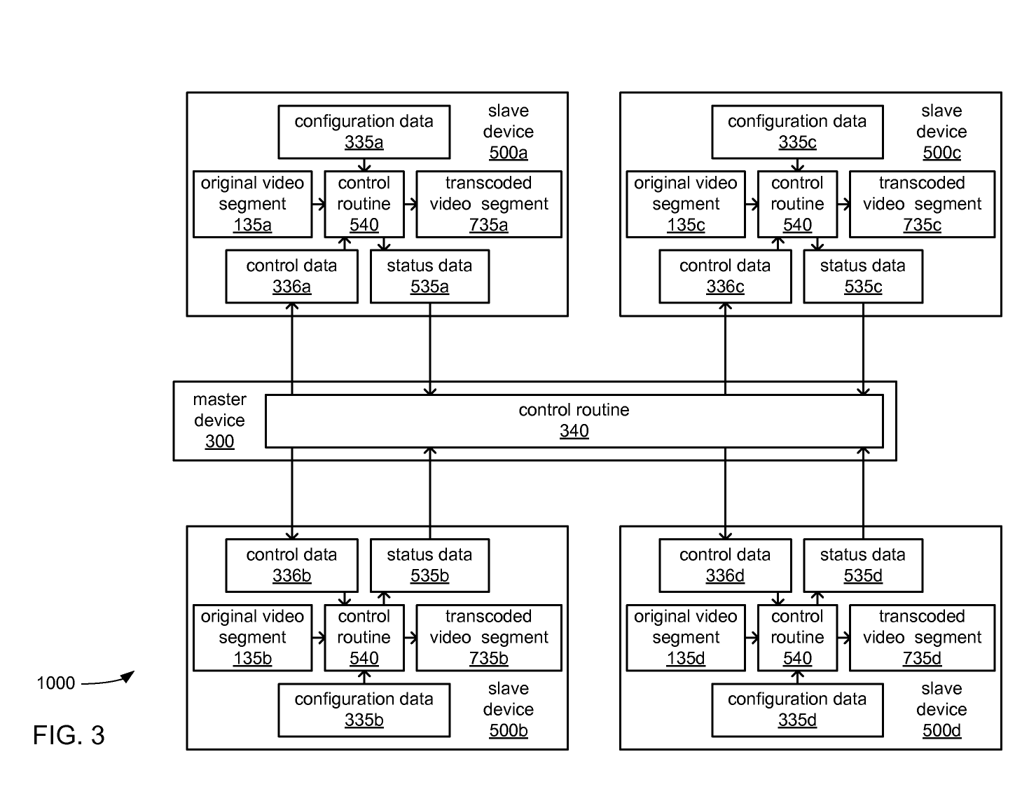

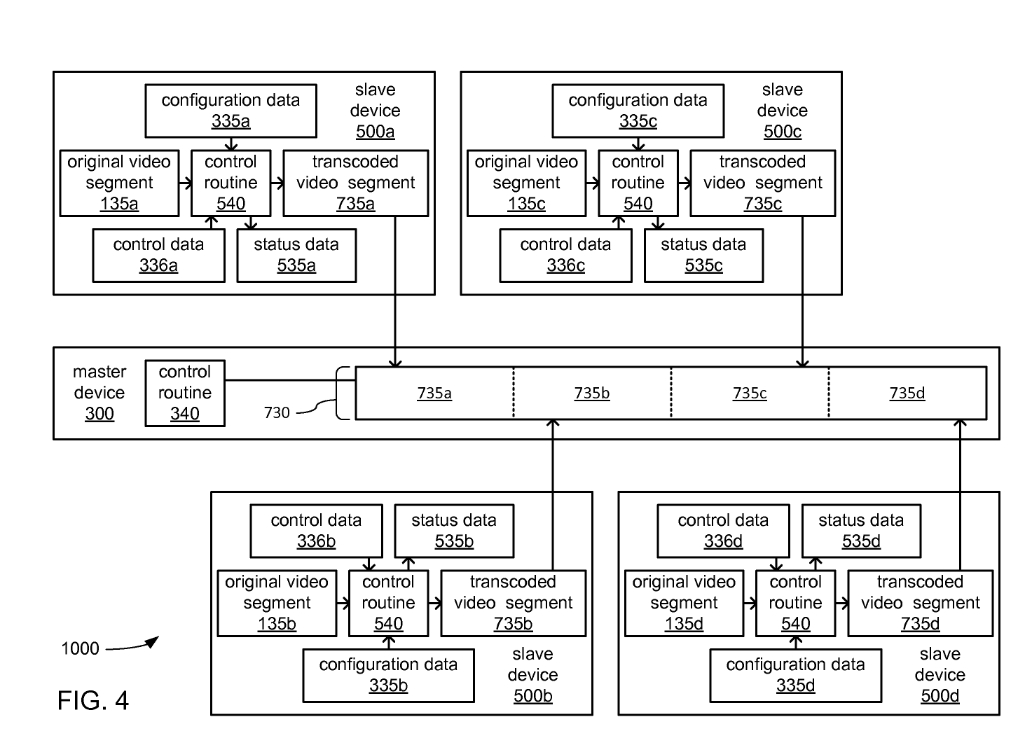

FIGS. 2, 3 and 4 are each a simplified block diagram of an embodiment of the video transcoding system 1000 of FIG. 1. Each of these figures depicts aspects of the operation of the video transcoding system 1000 at different phases. More specifically, FIG. 2 depicts aspects of preparations for transcoding the original video data 130 into the transcoded video data 730. FIG. 3 depicts aspects of that transcoding in progress. FIG. 4 depicts aspects of activity among the computing devices of the video transcoding system 1000 following that transcoding.

Turning to FIG. 2, the original video data 130 is divided into the original video segments 135a-d. As previously discussed, each of the video segments 135a-d are created to be substantially equal in size to enable all of them to be transcoded in parallel by respective ones of the slave devices 500a-d substantially simultaneously. As a result, the lengths of each of the video segments 135a-d are selected to enable the amount of time for each to transcoded to be substantially similar.

However, as those familiar with the manner in which various ones of the widely accepted video compression algorithms encode motion video frames in compressed form will readily recognize, it is not possible to simply subdivide motion video that has been so encoded between any two adjacent frames. This arises from the fact that majority of the frames in compressed motion video are not complete frames (e.g., intra-frames or I-frames) that include all of the pixel information of a complete viewable frame. Instead, the majority of the frames are difference frames made up of pixel information that describes the differences between that frame and another frame, such as one of the intra-frames or another difference frame. Further, the majority of the complete frames are used as references from which differences are described by difference frames that either precede or follow them, temporally. There is often a subset of the complete frames, commonly referred to as instantaneous decoder refresh frames or IDR-frames, that may be used as references from which differences are described only by difference frames that temporally follow them, and not by difference frames that temporally precede them.

An IDR-frame is always the first frame in a piece of motion video (e.g., the IDR-frame 136a at the beginning of the original video data 130), because it is a complete frame that does not use another frame as a reference, and because it is never preceded by a frame that references it. Thus, in determining locations in the original video data 130 at which to divide the original video data 130 into the original video segments 135a-d, the processor component 350 analyzes the frames of the original video data 130 in the vicinity of each such location to find one of the IDR-frames 136b, 136c or 136d at which each of the original video segments 135b, 135c and 135d, respectively, is to begin. Following this division of the original video data 130 into the original video segments 135a-d, the original video segments 135a-d are transmitted to respective ones of the slave devices 500a-d, as has been discussed.

Along with the original video segments 135a-d, the processor component 350 also transmits corresponding ones of configuration data 335a-d. Each of the configuration data 335a-d includes one or more of the earlier-described initial settings to be employed in performing transcoding by each of the slave devices 500a-d, respectively. By way of example, each of the configuration data 335a-d may indicate what forms of video processing are to be performed in transcoding the original video segments 135a-d into the transcoded video segments 735a-d. This information may have been provided to the master device 300 in the configuration data 330. As previously discussed, although video compression (for which one or more quantization parameters are provided to the slave devices 500a-d) is assumed to be a video processing operation that will be part of the transcoding to be done, one or more of any of a variety of other video processing operations may also be included.

Also, each of the configuration data 335a-d may include one or both of an initial value for a main quantization parameter to employ during normal operation and a value for an alternate quantization parameter to employ upon entry into a panic mode. In some embodiments, the processor component 350 may derive one or more quantization parameters to provide in the configuration data 335a-d from an analysis of each of the original video segments 135a-d and/or of the entirety of the original video data 130, as well as from whatever target bitrate and/or target range of bitrates may either be specified or derived by the processor component 350 from the configuration data 330. In other embodiments, at least one value for a main quantization parameter may be specified in the configuration data 335a-d with a default value selected based on an analysis of numerous pieces of motion video that may or may not include the piece of motion video represented by the original video data 130, or selected based on other aspects of prior experience. The alternate quantization parameter is selected to result in a considerably changed bitrate in comparison to the bitrates expected to result from other quantization parameter values that are otherwise expected to be used as main quantization parameters.

Further, each of the configuration data 335a-d may specify one or both of a main interval with which the slave devices 500a-d are to transmit an indication of their current bitrate to the master device 300, and an alternate interval to employ upon entry into a panic mode. In some embodiments, the main and/or alternate intervals are specified in the configuration data 335a-d as intervals of time, with the alternate interval selected to be shorter than the main interval. In other embodiments, the main and/or alternate intervals are specified as a number of IDR-frames (or number of other type of frame) encountered during compression between each instance of transmitting an indication of current bitrate to the master device 300, with the alternate interval selected to be a smaller number of IDR-frames (or other type of frame) than the initial interval.

It should be noted that one or more of the various settings conveyed to each of the slave devices 500a-d in the configuration data 335a-d, respectively, may differ. By way of example, while main intervals in which current bitrates are to be transmitted to the master device 300 may be identical for all of the slave devices 500a-d, one or more of the main quantization parameters may not be. Such dissimilarity in quantization parameters may arise from the processor component 350 having performed separate analyses on each of the original video segments 135a-d to separately derive at least one unique main quantization parameter for each.

Turning to FIG. 3, the original video segments 135a-d are transcoded into the transcoded video segments 735a-d by the processor components 550 of each of the slave devices 500a-d, respectively. As previously discussed, during transcoding, the processor components 550 of each of the slave devices 500a-d recurringly transmit indications of their current bitrates to the master device 300. These transmissions are depicted in FIG. 3 as the transfers of status data 535a-d from the slave devices 500a-d, respectively, to the master device 300. Again, these transmissions of current bitrates may occur at a main interval specified in corresponding ones of the configuration data 335a-d. The processor component 350 recurringly receives these indications of current bitrates in the recurring transmissions of each of the status data 535a-d. The processor component 350 recurringly sums the most recently received indications of current bitrate from each of the slave devices 500a-d to derive a total current bitrate therefrom. The processor component 350 recurringly compares the total current bitrate to a specific target bitrate (if provided) and/or to a target range of bitrates.

As further previously discussed, the processor components 550 of each of the slave devices 500a-d await receipt of transmissions from the master device 300 conveying indications to adjust a value of one or more quantization parameters. These transmissions are depicted in FIG. 3 as the transfers of the control data 336a-d from the master device 300 to the slave devices 500a-d, respectively. It is envisioned that the majority of such transmissions will convey an indication of an adjustment to at least one main quantization parameter derived by the processor component 350 to keep the total current bitrate relatively close to a specified target bitrate (e.g., reverse instances of the total current bitrate diverging from the specified target bitrate). However, where the current bitrate for one or more of the slave devices 500a-d increases relatively rapidly and/or where the total current bitrate ceases to remain within a target range of bitrates, then one or more of the control data 336a-d may convey an indication for a corresponding one or more of the slave devices 500a-d to enter a panic mode. In such a panic mode, the processor component 550 of a corresponding one or more slave devices 500a-d may switch from using a main quantization parameter to using an alternate quantization parameter to greatly change its current bitrate in a manner selected to cause the total current bitrate to once again fall within the target range of bitrates.

Alternatively, it may be that the signal transmitted by the processor component 350 to signal one or more of the slave devices 500a-d to enter into a panic mode is a relatively brief signal that does not convey data (e.g., the control data 336a-d indicating an adjusted main quantization parameter value). The processor component 550 of whichever ones of the slave devices 500a-d to which such a relatively brief signal is directed recognizes this relatively brief signal as an indication to immediately cease use of a main quantization parameter in favor of using an alternate quantization parameter transmitted earlier in a corresponding one of the configuration data 335a-d as specified for use in a panic mode. Such use of a more brief form of signal may be made to ensure that it is conveyed more quickly through the network 999 than other larger forms of network traffic, and to ensure that it can be recognized and acted upon more quickly by a one of the processor components 550 that receives it. By way of example, where signals conveying an instance of one of the control data 336a-d and conveying an indication to enter a panic mode are transmitted via the network 999 as packets, the signal conveying the indication to enter a panic mode may be a shorter packet that does not include a data payload portion. As those skilled in the art of various network protocols will readily recognize, larger packets conveying a data payload may be delayed due to their larger size in some types of network.

Turning to FIG. 4, the upon completion of the transcoding of the original video segments 135a-d into the transcoded video segments 735a-d by the processor components 550 of the slave devices 500a-d, respectively, the processor components 550 of the slave devices 500a-d transmit their transcoded video segments 735a-d to the master device 300. Upon receiving the transcoded video segments 735a-d from the slave devices 500a-d, respectively, the processor component 350 assembles the transcoded video segments 735a-dto generate the transcoded video data 730.

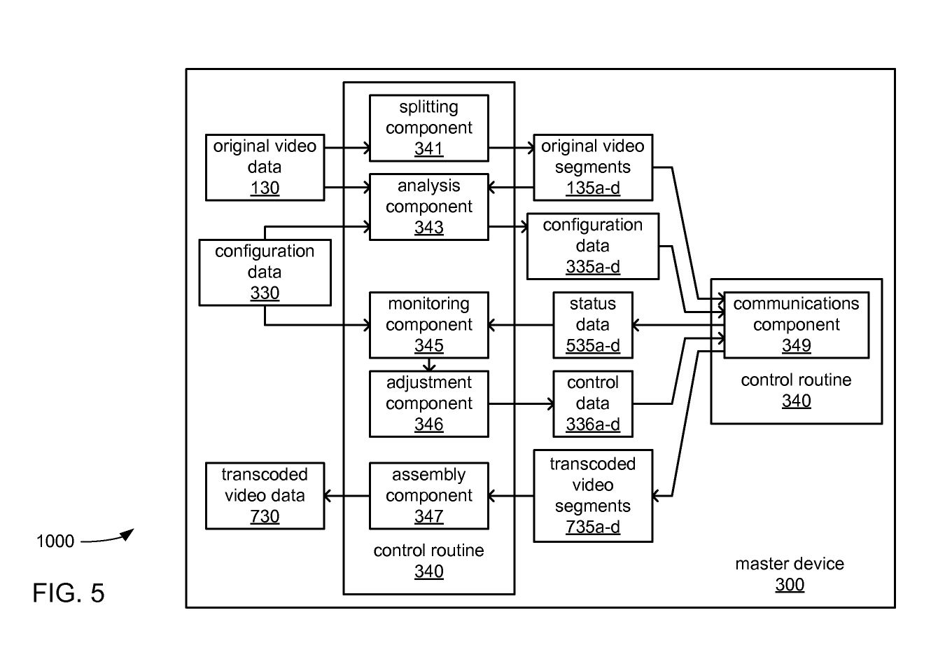

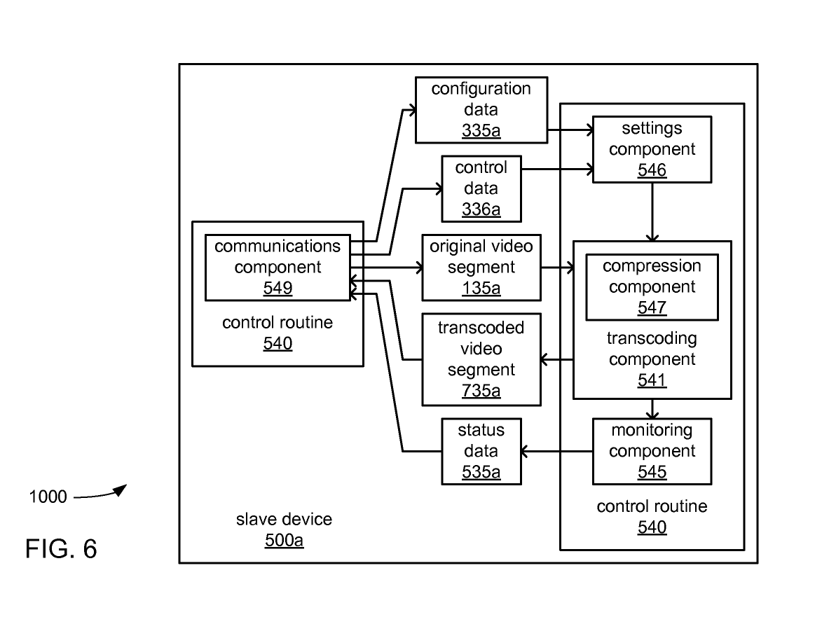

FIGS. 5 and 6 are each a block diagram of a portion of an embodiment of the video transcoding system 1000 of FIG. 1 depicted in greater detail. More specifically, FIG. 5 depicts aspects of the operating environment of the master device 300 in which the processor component 350, in executing the control routine 340, performs the aforedescribed functions in coordinating the transcoding of the original video data 130 into the transcoded video data 730. FIG. 6 depicts aspects of the operating environment of one of the slave devices 500a in which the processor component 550, in executing the control routine 540, performs the aforedescribed functions in transcoding the original video segment 135a into the transcoded video segment 735a. As will be recognized by those skilled in the art, the control routines 340 and 540, including the components of which each is composed, are selected to be operative on whatever type of processor or processors that are selected to implement applicable ones of the processor components 350 and 550.

In various embodiments, each of the control routines 340 and 540 may include one or more of an operating system, device drivers and/or application-level routines (e.g., so-called “software suites” provided on disc media, “applets” obtained from a remote server, etc.). Where an operating system is included, the operating system may be any of a variety of available operating systems appropriate for corresponding ones of the processor components 350 and 550. Where one or more device drivers are included, those device drivers may provide support for any of a variety of other components, whether hardware or software components, of corresponding ones of the computing devices 300 and 500.

The control routines 340 and 540 each include a communications component 349 and 549, respectively, executable by corresponding ones of the processor components 350 and 550 to operate the interfaces 390 and 590 to transmit and receive signals via the network 999 as has been described. Among the signals received may be signals conveying video data for transcoding and the video data that results therefrom, as well as signals coordinating such transcoding. As will be recognized by those skilled in the art, each of these communications components is selected to be operable with whatever type of interface technology is selected to implement corresponding ones of the interfaces 390 and 590.

The control routine 340 includes a splitting component 341 executable by the processor component 350 to divide the original video data 130 into segments based on one or more of the quantity of slave devices to be used in performing transcoding and possibly also based on locations of IDR-frames within the original video data 130, as has been described. Thus, given the quantity of four slave devices, namely the slave devices 500a-d, the splitting component 341 generates the four original video segments 135a-d.

The control routine 340 may include an analysis component 343 executable by the processor component 350 to analyze the original video data 130 and/or the original video segments 135a-d to derive one or more quantization parameters. In so doing, the analysis component 343 may also analyze whatever indications may be provided in the configuration data 330 of a target range of bitrates for the compression portion of the transcoding to be done. As has been discussed, such derived quantization parameter(s) may be conveyed to the slave devices 500a-d as one or more main quantization parameters in corresponding ones of the configuration data 335a-d, as has been described.

The control routine 340 includes a monitoring component 345 executable by the processor component 350 to receive the indications of current bitrates from each of the slave devices 500a-d that are recurringly transmitted to the master device 300 as corresponding ones of the status data 535a-d. The monitoring component 345 recurringly derives the total current bitrate by summing the most recently received current bitrates from each of the slaves 500a-d, and recurringly compares that total current bitrate to a specific target bitrate and/or target range of bitrates either specified by in the configuration data 330 or derived from other data indicated in the configuration data 330 (e.g., a specific target data size or a target range of data sizes).

The control routine 340 includes an adjustment component 346 executable by the processor component 350 to receive indications from the monitoring component 345 of results of recurring comparisons of total current bitrate to one or both of a specified target bitrate and a target range of bitrates. In embodiments where a specific target bitrate is provided, the adjustment component derives one or more adjusted values for main quantization parameter(s) to be transmitted to one or more of the slave devices 500a-d as corresponding ones of the control data 336a-d. The one or more adjusted values for main quantization parameters are selected to change the current bitrate of one or more of the slave devices 500a-d to cause the resulting total current bitrate to remain relatively close to the specified target bitrate.

The adjustment component 346 may use any of a variety of algorithms to derive the one or more adjusted values and/or to select one or more of the slave devices 500a-d to provide adjusted values to. By way of example, where the total current bitrate increases such that it rises to increasingly higher levels than the specified target bitrate, the adjustment component 346 may select to adjust main quantization parameters of each of the slave devices 500a-d by the same proportionate degree to attempt to alter all of the current bitrates by a relatively small amount to cause the total current bitrate to remain closer to that target bitrate. By way of another example, where the current bitrate of one of the slave devices 500a-d begins to change rapidly such that it is likely to cause the total current bitrate to cease to be relatively close to the target bitrate, the adjustment component 346 may select to adjust a main quantization parameter of that particular one of the slave devices 500a-d to at least reduce the extent to which the current bitrate of that particular one of the slave devices 500a-d changes.

Regardless of whether or not a specific target bitrate has been specified, where the total current bitrate ceases to remain within a target range of bitrates, the adjustment component 346 signals one or more of the slave devices 500a-d (via the communications component 349) to enter a panic mode. As has been discussed, the one or more of the slave devices 500a-d to which such a signal has been directed commences use of an alternate quantization parameter selected to cause a significant change in current bitrate to bring the total current bitrate back within the target range of bitrates.

The control routine 340 includes an assembly component 347 executable by the processor component 350 to receive the transcoded video segments 735a-d from corresponding ones of the slave devices 500a-d, and to assemble them into the transcoded video data 730. As has been described, the processor component 350, in executing the control routine 340, may then visually present the transcoded video data 730 on the display 380 (if present) and/or may operate the interface 390 (via the communications component 349) to transmit the transcoded video data 730 to another computing device.

The control routine 540 includes a transcoding component 541 executable by the processor component 550 to perform whatever form of transcoding has been directed to be performed on the original video segment 135a to generate the transcoded video segment 735a, as has been described. The configuration data 335a may include an indication of what video processing is to be done as part of the transcoding, in addition to compression performed by a compression component 547 making up part of the transcoding component 541.

The control routine 540 includes a settings component 546 executable by the processor component 550 to receive both the initial settings conveyed to the slave device 500a in the configuration data 335a prior to the start of transcoding, and whatever adjusted values for main quantization parameter(s) may be conveyed in one or more transmissions of the control data 336a during transcoding. The settings component 546 provides the main or alternate quantization parameters (as appropriate) to the compression component 547 to use in the compression portion of the transcoding that is performed, as has been described. The settings component 546 may also receive signals that may be transmitted by the master device 300 to indicate that the slave device 500a is to enter a panic mode. Upon receipt of such a panic mode signal, the settings component 546 conveys one or more alternate quantization parameter(s) provided to the settings component 546 in the configuration data 335a for use in a panic mode. As has been described, the alternate quantization parameter(s) provided for a panic mode are selected to cause a considerable reduction in the current bitrate of the compression portion of the transcoding operation as compared to the main quantization parameter(s) initially conveyed in the configuration data 335a and/or subsequently adjusted in the control data 336a.

The control routine 540 includes a monitoring component 545 executable by the processor component 550 to recurringly monitor and convey the current bitrate for the compression portion of the transcoding performed by the processor component 550 (via the compression component 547) of the slave device 500a to the master device 300 in the status data 535a. As has been discussed, the configuration data 335a may specify a main interval of time or quantity of IDR-frames at which the current bitrate is to be transmitted to the master device 300. Further, the configuration data 335a may also specify an alternate interval of time or quantity of IDR-frames at which the current bitrate is to be transmitted to the master device 300 during a panic mode, the alternate interval being selected to be smaller than the main interval to cause the current bitrate to be transmitted more frequently during a panic mode.

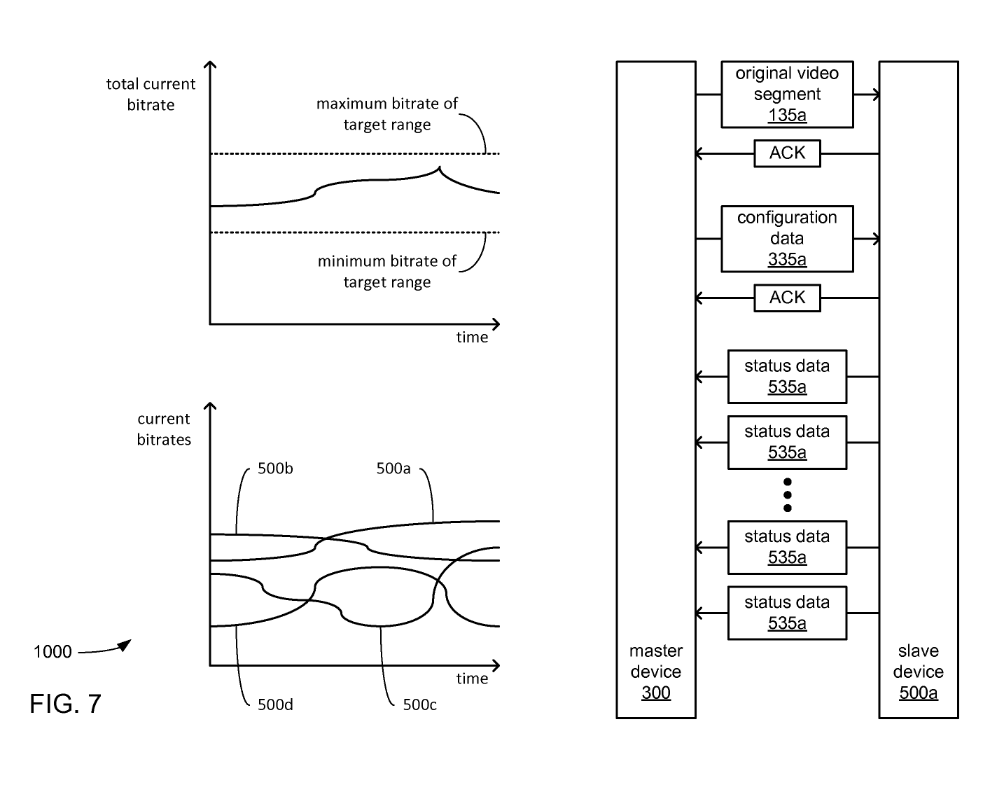

FIGS. 7, 8 and 9 each depict aspects of example of the operation of an embodiment of the video transcoding system 1000 of FIG. 1. More specifically, each of these figures depicts aspects of the monitoring and response to changes in the current bitrate of each of the slave devices 500a-d by the master device 300, including examples of exchanges of signals between the master device 300 and the slave device 500a.

Turning to FIG. 7, graphs depicting an example of individual current bitrates of each of the slave devices 500a-d and the total current bitrate derived from those individual current bitrates are presented in a manner in which their time axes are aligned to illustrate cause and effect therebetween. Alongside these graphs, a corresponding example exchange of signals between the master device 300 and the slave device 500a is also presented for embodiments in which the processor component 350 of the master device 300 is caused to recurringly check whether the current total bitrate remains within a target range of bitrates, but not necessarily to check whether the current total bitrate remains relatively close to a specified target bitrate.

As depicted and has been discussed, the current bitrates of each of the slave devices 500a-d in performing the compression portion of the transcoding performed in parallel by the slave devices 500a-d can vary considerably over time as video compression is performed. As also depicted, as long as the resulting total current bitrate remains within the target range of bitrates (i.e., below the maximum bitrate and above the minimum bitrate depicted with dotted lines), fluctuations in the individual current bitrates of the slave devices 500a-d may be permitted to occur by the master device 300. Stated differently, as long as an increase in the current bitrate of one or more of the slave devices 500a-d is offset by a corresponding decrease in the current bitrate of one or more others of the slave devices 500a-d such that the total current bitrate remains within the target range of bitrates, the master device 300 may take no action to alter one or more of these current bitrates.

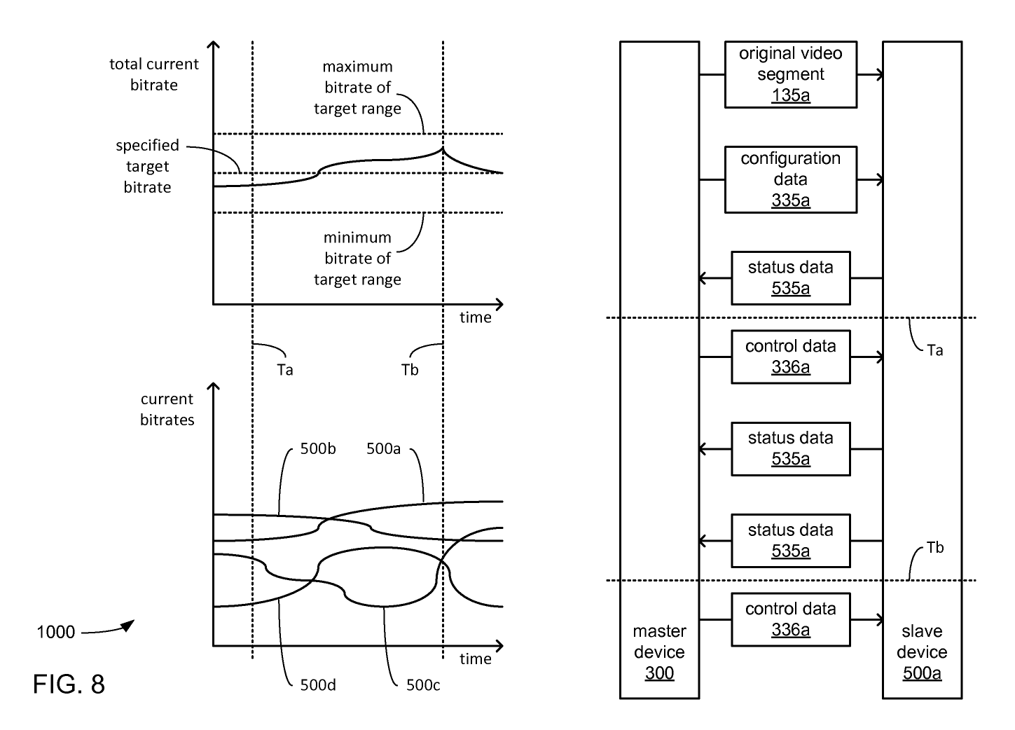

This lack of action by the master device 300 is reflected in the accompanying depiction of signal activity between the master device 300 and the slave device 500a. As depicted, the master device 300 initially transmits the original video segment 135a to the slave device 500a. In some embodiments, and as depicted in FIG. 8a, a handshake protocol may exist in which the slave device 500a responds to successfully receiving the original video segment 135a by transmitting an acknowledgement signal (ACK) back to the master device 300. Also transmitted by the master device 300 to the slave device 500a is the configuration data 335a, and again, the slave device 500a may respond with an ACK signal. It should be noted that despite this depiction of a relatively simple provision of the configuration data 335a by the master device 300 to the slave device 500a, embodiments are possible in which the master device 300 and the slave device 500a exchange multiple signals as part of performing a negotiation via the network 999 to agree upon one or more of the initial settings to be used by the slave device 500a in performing the transcoding of the original video segment 135a. By way of example, the length of an interval (whether specified as a measure of time or a quantity of IDR-frames) at which the slave device 500a is to transmit its current bitrate to the master device 300 may be so negotiated.

Following commencement of the transcoding of the original video segment 135a, and corresponding to the depiction of the current bitrates of the slave device 500a-d in the initial time period of FIG. 7, the slave device 500a recurringly transmits its current bitrate in multiple instances of the status data 535a to the master device 300. Since, in this example, the total current bitrate remains within the target range of bitrates, the master device 300 does not transmit any signal to the slave device 500a to adjust a main quantization parameter.

Turning to FIG. 8, graphs depicting the same example of individual current bitrates of each of the slave devices 500a-d and the same total current bitrate derived from those individual current bitrates are presented as were presented in FIG. 7, and in the same aligned manner to illustrate cause and effect therebetween. However, alongside these graphs in FIG. 8, a corresponding example exchange of signals between the master device 300 and the slave device 500a is also presented for embodiments in which the processor component 350 is caused to recurringly check whether the current total bitrate remains close to a specified target bitrate, instead of simply within a target range of bitrates.

As depicted, at example timepoints Ta and Tb, where one or more of the current bitrates of individual ones of the slave devices 500a-d vary to an extent that the total current bitrate is not as close to the specified target bitrate as at other times, the master device 300 responds by transmitting instances of the control data 336a conveying an adjusted value for a main quantization parameter to at least the slave device 500a. More specifically, the depicted signal activity begins similarly to what is depicted in FIG. 7 with the transmission of the original video segment 135a and the configuration data 335a by the master device 300 to the slave device 500a (depictions of the transmission of ACK signals by the slave device 500a have been omitted for sake of visual clarity). As also depicted in FIG. 7, the slave device 500a recurringly transmits instances of the status data 535a to the master device 300 to recurringly convey its current bitrate, as has been discussed. However, in response to the receipt of at least the instances of the status data 535a from the slave device 500a at about the timepoints Ta and Tb, the master device 300 transmits instances of the control data 336a conveying indications of adjusted values for main quantization parameter(s) at about those same timepoints. Thus, FIG. 8 depicts an example of an embodiment in which the master device 300 acts to attempt to keep the total current bitrate relatively close to a specified target bitrate.

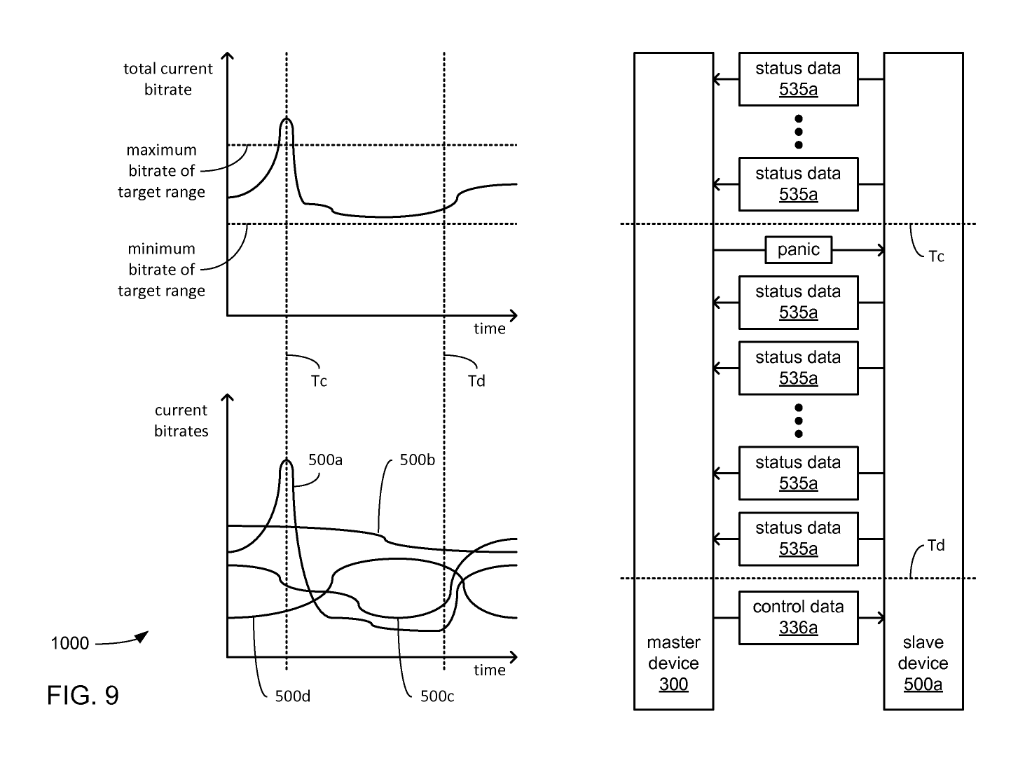

Turning to FIG. 9, similar time-aligned graphs depicting an example of a different pattern of varying values of current bitrates and a resulting total current bitrate are presented. Specifically, an example instance is depicted of the current bitrate of the slave device 500a rapidly increases leading up to a timepoint Tc. This rapid increase in the current bitrate of the slave device 500a is not sufficiently offset by any decrease in bitrate occurring among the other current bitrates of the other slave devices 500b-d, and this results in the total current bitrate also rapidly rising such that it exceeds the maximum bitrate of the target range of bitrates leading up to the timepoint Tc.

In response, at the timepoint Tc, the master device 300 signals the slave device 500a to enter into a panic mode. The slave device 500a does so at or about the timepoint Tc, ceasing to use a main quantization parameter that was in use during the rapid increase in its current bitrate up to the timepoint Tc, and begins using an alternate quantization parameter selected for use during a panic mode, causing a substantial reduction in the current bitrate of the slave device 500a, as shown to occur relatively quickly after the timepoint Tc. As a result of this relatively quick reduction in the current bitrate of the slave device 500a, the total current bitrate is also reduced, causing it to once again fall within the target range of bitrates relatively quickly after the timepoint Tc.

As has been discussed, during such a panic mode, the slave device 500a recurringly transmits indications of its current bitrate to the master device 300 with shorter intervals than when not in a panic mode. In some embodiments, a form of delay before ending a panic mode may be imposed by the master device 300 to ensure that whatever conditions in the compression of the video segment 135a that precipitated the rapid rise in current bitrate have passed. Thus, at timepoint Td after at least such a delay from timepoint Tc, the master device 300 signals the slave device 500a to exit the panic mode. The slave device 500a then ceases employing the alternate quantization parameter of the panic mode and again uses a main quantization parameter such that its current bitrate is allowed to rise again, as is depicted following the timepoint Tc.

Turning to the corresponding depiction of an exchange of signals between the master device 300 and the slave device 500a in FIG. 9, the slave device 500a recurringly transmits instances of the status data 535a to recurringly convey its current bitrate to the master device 300 in a manner similar to what has been discussed in the preceding examples of FIGS. 7 and 8. However, in response to the aforedescribed rapid rise in the bitrate of the slave device 500a leading up to timepoint Tc, the master device 300 transmits a panic signal to the slave device 500a at timepoint Tc. As has been described, the slave device 500a responds by ceasing to use a main quantization parameter and by commencing use of an alternate quantization parameter. As has also been described, the slave device 500a may further respond by recurringly transmitting its current bitrate to the master device 500 more frequently (i.e., with a smaller interval between such transmissions).

Following the recurring transmission of its current bitrate during the panic mode for what may be a period of time that includes an inserted delay, the master device 300 transmits an indication to the slave device 500a at about the timepoint Td to exit the panic mode. In some embodiments, this indication to the slave device 500a to exit the panic mode may be another relatively brief signal that, like the panic signal, does not convey data. In other embodiments, and as depicted in FIG. 9, the signal to the slave device 500a to exit the panic mode may be a transmission of an instance of the control data 336a. In such a transmission, the control data 336a may convey the indication to exit the panic mode as a binary or other value in that instance of the control data 336a. Alternatively or additionally, that instance of the control data 336a may include an adjusted value for a main quantization parameter for the slave device 500a to use in the compression portion of its transcoding of the original video segment 135a in lieu of continuing to use the alternate quantization parameter associated with the panic mode.

As has been discussed, the panic signal transmitted by the master device 300 to the slave device 500a may differ from a signal transmitted by the master device 300 to convey the control data 336a inasmuch as the panic signal may be shorter in duration. It should further be noted that such a difference may arise from the use of different types of packets conveyed through the network 999 for the panic signal versus the control data 336a. More specifically, in some embodiments, the panic signal may be transmitted in a shorter packet that perhaps does not include a data payload, but instead conveys the fact of its being a panic signal via one or more bits of a header.

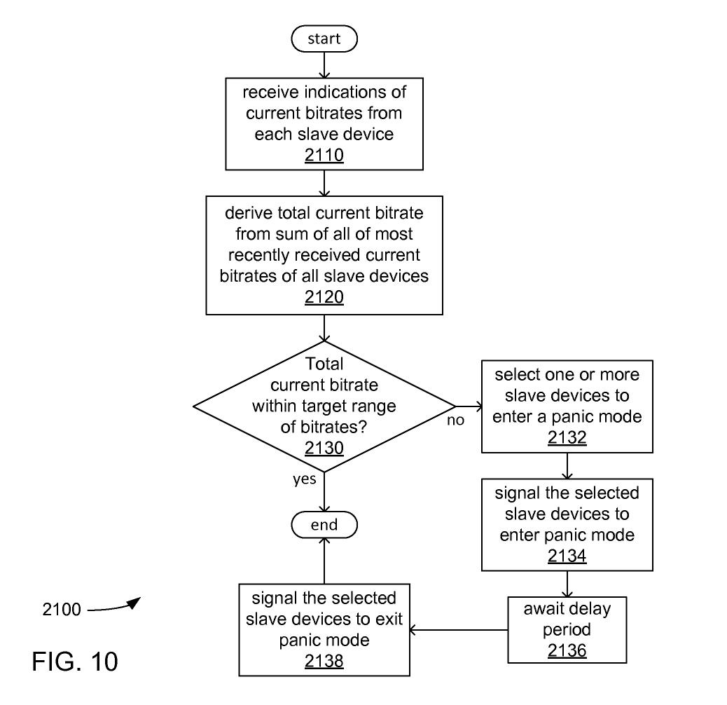

FIG. 10 illustrates one embodiment of a logic flow 2100. The logic flow 2100 may be representative of some or all of the operations executed by one or more embodiments described herein. More specifically, the logic flow 2100 may illustrate operations performed by the processor component 350 in executing at least the control routine 340, and/or performed by other component(s) of the master device 300.

At 2110, a processor component of a master device of a transcoding system (e.g., the processor component 350 of the master device 300 of the transcoding system 1000) receives indications of current bitrate from each of multiple slave devices (e.g., the slave devices 500a-d) performing substantially parallel transcoding of segments of an original video data (e.g., the original video segments 135a-d) to generate corresponding segments of a transcoded video data (e.g., the transcoded video segments 735a-d). As has been discussed, an original video data is divided into a number of segments equal to the number of slave devices of a video transcoding system to be used, and each of those slave devices recurringly transmits indications to the master device of the current bitrate required for the encoding of current portions of their respective segments.

At 2120, the most recent indications of current bitrate from each of the slave devices are summed to derive a total current bitrate for use in comparisons to one or both of a specified target bitrate or a target range of bitrates for the transcoded video to achieve (or at least come relatively close to). A check is made at 2130 as to whether the total current bitrate is within the target range of bitrates.

If, at 2130, the total current bitrate is not within the target range, then one or more of the slave devices are selected to enter a panic mode at 2132, and those selected slave devices are signaled to enter a panic mode at 2134. As has been discussed, entry into a panic by one of the slave devices entails that slave device ceasing to use a main quantization parameter and commencing use of an alternate quantization parameter in a compression portion of the transcoding it performs. At 2136, a delay is awaited to allow what may be sufficient time to have passed since the onset of the panic mode to allow the conditions that precipitated entry into the panic mode to subside, and the at least one slave device is then signaled to exit the panic mode. The selected slave devices are then signaled to exit panic mode at 2138.

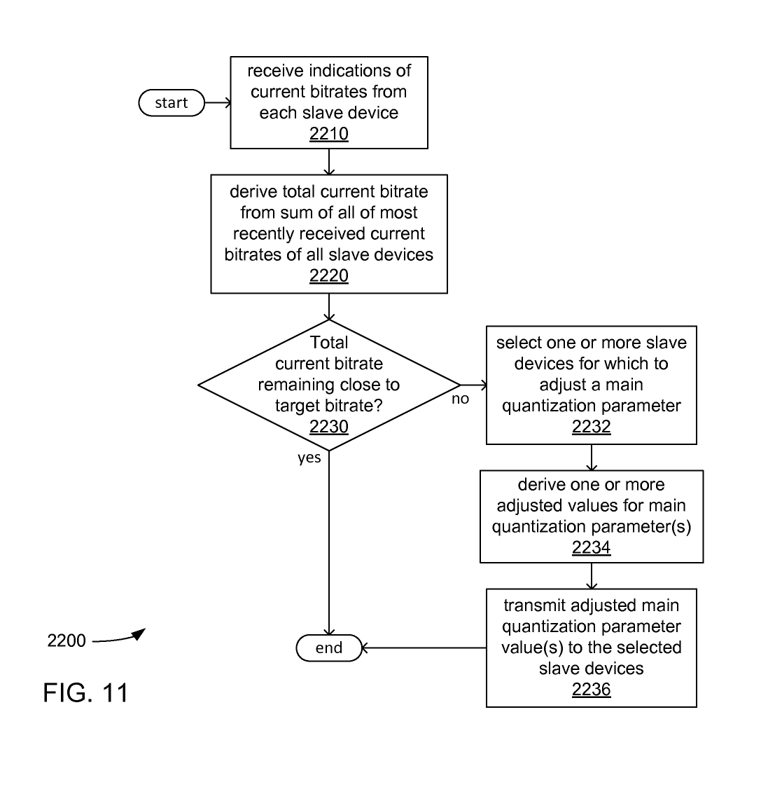

FIG. 11 illustrates one embodiment of a logic flow 2200. The logic flow 2200 may be representative of some or all of the operations executed by one or more embodiments described herein. More specifically, the logic flow 2200 may illustrate operations performed by the processor component 350 in executing at least the control routine 340, and/or performed by other component(s) of the master device 300.

At 2210, a processor component of a master device of a transcoding system (e.g., the processor component 350 of the master device 300 of the transcoding system 1000) receives indications of current bitrate from each of multiple slave devices (e.g., the slave devices 500a-d) performing substantially parallel transcoding of segments of an original video data (e.g., the original video segments 135a-d) to generate corresponding segments of a transcoded video data (e.g., the transcoded video segments 735a-d). At 2220, the most recent indications of current bitrate from each of the slave devices are summed to derive a total current bitrate for use in comparisons to one or both of a specified target bitrate or a target range of bitrates for the transcoded video to achieve (or at least come relatively close to).

A check is made at 2230 as to whether the total current bitrate is remaining close to a specified target bitrate or is diverging therefrom. As has been discussed, the master device may recurringly analyze changes in the current bitrates of each of the slave devices to project whether the total current bitrate will remain close to the specified target bitrate or diverge therefrom, and then derive adjusted values for one or more main quantization parameters to prevent (or stop) such divergence.

If, at 2230, the total current bitrate is not remaining close to the target bitrate (e.g., is diverging or is projected to diverge therefrom), then one or more of the slave devices are selected to be provided with adjusted values for main quantization parameters at 2232. Those adjusted values are then derived at 2234, and are then transmitted to the selected ones of the slave devices at 2236.

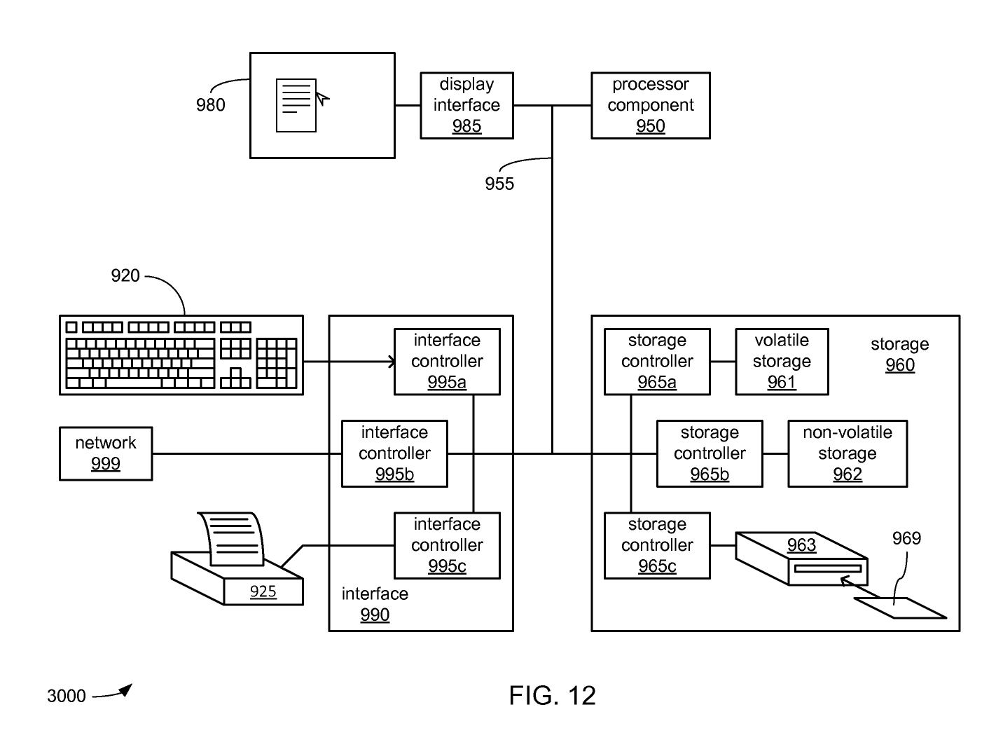

FIG. 12 illustrates an embodiment of an exemplary processing architecture 3000 suitable for implementing various embodiments as previously described. More specifically, the processing architecture 3000 (or variants thereof) may be implemented as part of one or more of the computing devices 100, 300, or 600, as well as possibly the controller 400. It should be noted that components of the processing architecture 3000 are given reference numbers in which the last two digits correspond to the last two digits of reference numbers of at least some of the components earlier depicted and described as part of the computing devices 100, 300 and 600, as well as the controller 400. This is done as an aid to correlating components of each.

The processing architecture 3000 includes various elements commonly employed in digital processing, including without limitation, one or more processors, multi-core processors, co-processors, memory units, chipsets, controllers, peripherals, interfaces, oscillators, timing devices, video cards, audio cards, multimedia input/output (I/O) components, power supplies, etc. As used in this application, the terms “system” and “component” are intended to refer to an entity of a computing device in which digital processing is carried out, that entity being hardware, a combination of hardware and software, software, or software in execution, examples of which are provided by this depicted exemplary processing architecture. For example, a component can be, but is not limited to being, a process running on a processor component, the processor component itself, a storage device (e.g., a hard disk drive, multiple storage drives in an array, etc.) that may employ an optical and/or magnetic storage medium, an software object, an executable sequence of instructions, a thread of execution, a program, and/or an entire computing device (e.g., an entire computer). By way of illustration, both an application running on a server and the server can be a component. One or more components can reside within a process and/or thread of execution, and a component can be localized on one computing device and/or distributed between two or more computing devices. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to one or more signal lines. A message (including a command, status, address or data message) may be one of such signals or may be a plurality of such signals, and may be transmitted either serially or substantially in parallel through any of a variety of connections and/or interfaces.

As depicted, in implementing the processing architecture 3000, a computing device includes at least a processor component 950, a storage 960, an interface 990 to other devices, and a coupling 955. As will be explained, depending on various aspects of a computing device implementing the processing architecture 3000, including its intended use and/or conditions of use, such a computing device may further include additional components, such as without limitation, a display interface 985.

The coupling 955 includes one or more buses, point-to-point interconnects, transceivers, buffers, crosspoint switches, and/or other conductors and/or logic that communicatively couples at least the processor component 950 to the storage 960. Coupling 955 may further couple the processor component 950 to one or more of the interface 990, the audio subsystem 970 and the display interface 985 (depending on which of these and/or other components are also present). With the processor component 950 being so coupled by couplings 955, the processor component 950 is able to perform the various ones of the tasks described at length, above, for whichever one(s) of the aforedescribed computing devices implement the processing architecture 3000. Coupling 955 may be implemented with any of a variety of technologies or combinations of technologies by which signals are optically and/or electrically conveyed. Further, at least portions of couplings 955 may employ timings and/or protocols conforming to any of a wide variety of industry standards, including without limitation, Accelerated Graphics Port (AGP), CardBus, Extended Industry Standard Architecture (E-ISA), Micro Channel Architecture (MCA), NuBus, Peripheral Component Interconnect (Extended) (PCI-X), PCI Express (PCI-E), Personal Computer Memory Card International Association (PCMCIA) bus, HyperTransport™, QuickPath, and the like.

As previously discussed, the processor component 950 (corresponding to the processor components 150, 350 and 650) may include any of a wide variety of commercially available processors, employing any of a wide variety of technologies and implemented with one or more cores physically combined in any of a number of ways.

As previously discussed, the storage 960 (corresponding to the storages 160, 360 and 660) may be made up of one or more distinct storage devices based on any of a wide variety of technologies or combinations of technologies. More specifically, as depicted, the storage 960 may include one or more of a volatile storage 961 (e.g., solid state storage based on one or more forms of RAM technology), a non-volatile storage 962 (e.g., solid state, ferromagnetic or other storage not requiring a constant provision of electric power to preserve their contents), and a removable media storage 963 (e.g., removable disc or solid state memory card storage by which information may be conveyed between computing devices). This depiction of the storage 960 as possibly including multiple distinct types of storage is in recognition of the commonplace use of more than one type of storage device in computing devices in which one type provides relatively rapid reading and writing capabilities enabling more rapid manipulation of data by the processor component 950 (but possibly using a “volatile” technology constantly requiring electric power) while another type provides relatively high density of non-volatile storage (but likely provides relatively slow reading and writing capabilities).

Given the often different characteristics of different storage devices employing different technologies, it is also commonplace for such different storage devices to be coupled to other portions of a computing device through different storage controllers coupled to their differing storage devices through different interfaces. By way of example, where the volatile storage 961 is present and is based on RAM technology, the volatile storage 961 may be communicatively coupled to coupling 955 through a storage controller 965a providing an appropriate interface to the volatile storage 961 that perhaps employs row and column addressing, and where the storage controller 965a may perform row refreshing and/or other maintenance tasks to aid in preserving information stored within the volatile storage 961. By way of another example, where the non-volatile storage 962 is present and includes one or more ferromagnetic and/or solid-state disk drives, the non-volatile storage 962 may be communicatively coupled to coupling 955 through a storage controller 965b providing an appropriate interface to the non-volatile storage 962 that perhaps employs addressing of blocks of information and/or of cylinders and sectors. By way of still another example, where the removable media storage 963 is present and includes one or more optical and/or solid-state disk drives employing one or more pieces of machine-readable storage medium 969, the removable media storage 963 may be communicatively coupled to coupling 955 through a storage controller 965c providing an appropriate interface to the removable media storage 963 that perhaps employs addressing of blocks of information, and where the storage controller 965c may coordinate read, erase and write operations in a manner specific to extending the lifespan of the machine-readable storage medium 969.

One or the other of the volatile storage 961 or the non-volatile storage 962 may include an article of manufacture in the form of a machine-readable storage media on which a routine including a sequence of instructions executable by the processor component 950 may be stored, depending on the technologies on which each is based. By way of example, where the non-volatile storage 962 includes ferromagnetic-based disk drives (e.g., so-called “hard drives”), each such disk drive typically employs one or more rotating platters on which a coating of magnetically responsive particles is deposited and magnetically oriented in various patterns to store information, such as a sequence of instructions, in a manner akin to storage medium such as a floppy diskette. By way of another example, the non-volatile storage 962 may be made up of banks of solid-state storage devices to store information, such as sequences of instructions, in a manner akin to a compact flash card. Again, it is commonplace to employ differing types of storage devices in a computing device at different times to store executable routines and/or data. Thus, a routine including a sequence of instructions to be executed by the processor component 950 may initially be stored on the machine-readable storage medium 969, and the removable media storage 963 may be subsequently employed in copying that routine to the non-volatile storage 962 for longer term storage not requiring the continuing presence of the machine-readable storage medium 969 and/or the volatile storage 961 to enable more rapid access by the processor component 950 as that routine is executed.

As previously discussed, the interface 990 (possibly corresponding to the interfaces 190, 390 or 690) may employ any of a variety of signaling technologies corresponding to any of a variety of communications technologies that may be employed to communicatively couple a computing device to one or more other devices. Again, one or both of various forms of wired or wireless signaling may be employed to enable the processor component 950 to interact with input/output devices (e.g., the depicted example keyboard 920 or printer 925) and/or other computing devices, possibly through a network (e.g., the network 999) or an interconnected set of networks. In recognition of the often greatly different character of multiple types of signaling and/or protocols that must often be supported by any one computing device, the interface 990 is depicted as including multiple different interface controllers 995a, 995b and 995c. The interface controller 995a may employ any of a variety of types of wired digital serial interface or radio frequency wireless interface to receive serially transmitted messages from user input devices, such as the depicted keyboard 920. The interface controller 995b may employ any of a variety of cabling-based or wireless signaling, timings and/or protocols to access other computing devices through the depicted network 999 (perhaps a network made up of one or more links, smaller networks, or perhaps the Internet). The interface 995c may employ any of a variety of electrically conductive cabling enabling the use of either serial or parallel signal transmission to convey data to the depicted printer 925. Other examples of devices that may be communicatively coupled through one or more interface controllers of the interface 990 include, without limitation, microphones, remote controls, stylus pens, card readers, finger print readers, virtual reality interaction gloves, graphical input tablets, joysticks, other keyboards, retina scanners, the touch input component of touch screens, trackballs, various sensors, a camera or camera array to monitor movement of persons to accept commands and/or data signaled by those persons via gestures and/or facial expressions, laser printers, inkjet printers, mechanical robots, milling machines, etc.

Where a computing device is communicatively coupled to (or perhaps, actually incorporates) a display (e.g., the depicted example display 980, corresponding to the display 380 or 680), such a computing device implementing the processing architecture 3000 may also include the display interface 985. Although more generalized types of interface may be employed in communicatively coupling to a display, the somewhat specialized additional processing often required in visually displaying various forms of content on a display, as well as the somewhat specialized nature of the cabling-based interfaces used, often makes the provision of a distinct display interface desirable. Wired and/or wireless signaling technologies that may be employed by the display interface 985 in a communicative coupling of the display 980 may make use of signaling and/or protocols that conform to any of a variety of industry standards, including without limitation, any of a variety of analog video interfaces, Digital Video Interface (DVI), DisplayPort, etc.

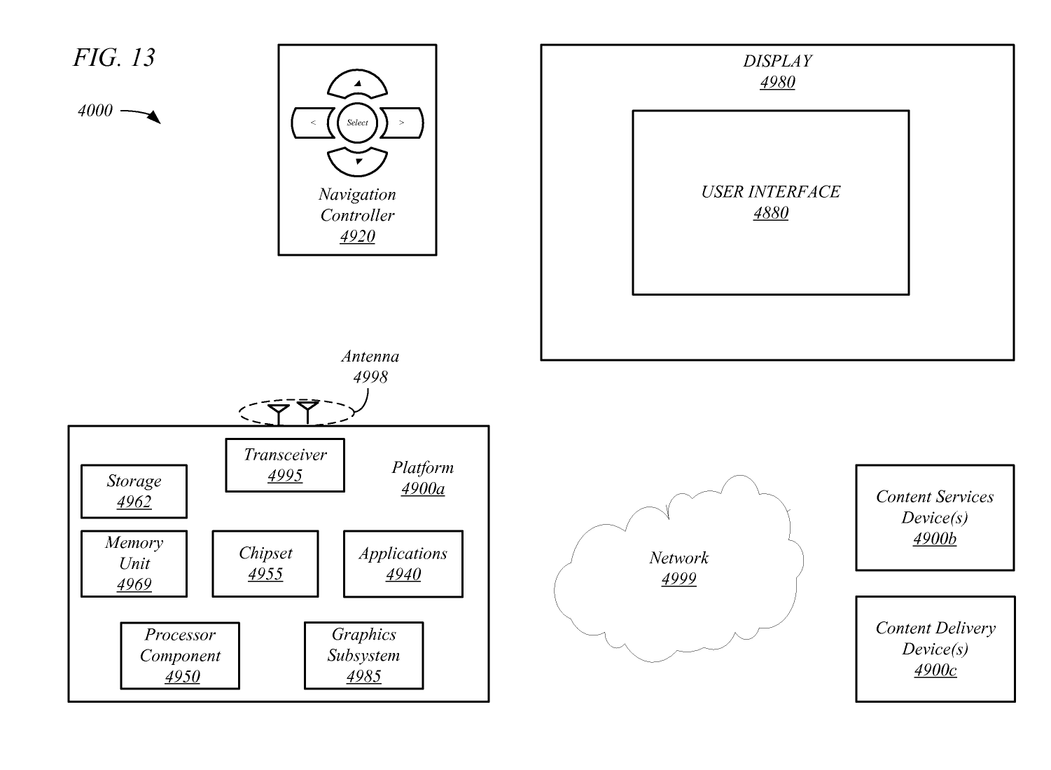

FIG. 13 illustrates an embodiment of a system 4000. In various embodiments, system 4000 may be representative of a system or architecture suitable for use with one or more embodiments described herein, such as the video transcoding system 1000; one or more of the computing devices 100, 300, 500a-d or 700; and/or one or both of the logic flows 2100 or 2200. The embodiments are not limited in this respect.

As shown, system 4000 may include multiple elements. One or more elements may be implemented using one or more circuits, components, registers, processors, software subroutines, modules, or any combination thereof, as desired for a given set of design or performance constraints. Although this figure shows a limited number of elements in a certain topology by way of example, it can be appreciated that more or less elements in any suitable topology may be used in system 4000 as desired for a given implementation. The embodiments are not limited in this context.

In embodiments, system 4000 may be a media system although system 4000 is not limited to this context. For example, system 4000 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In embodiments, system 4000 includes a platform 4900a coupled to a display 4980. Platform 4900a may receive content from a content device such as content services device(s) 4900c or content delivery device(s) 4900d or other similar content sources. A navigation controller 4920 including one or more navigation features may be used to interact with, for example, platform 4900a and/or display 4980. Each of these components is described in more detail below.

In embodiments, platform 4900a may include any combination of a processor component 4950, chipset 4955, memory unit 4969, transceiver 4995, storage 4962, applications 4940, and/or graphics subsystem 4985. Chipset 4955 may provide intercommunication among processor circuit 4950, memory unit 4969, transceiver 4995, storage 4962, applications 4940, and/or graphics subsystem 4985. For example, chipset 4955 may include a storage adapter (not depicted) capable of providing intercommunication with storage 4962.

Processor component 4950 may be implemented using any processor or logic device, and may be the same as or similar to one or more of processor components 350 or 550, and/or to processor component 950 of FIG. 12.

Memory unit 4969 may be implemented using any machine-readable or computer-readable media capable of storing data, and may be the same as or similar to storage media 969 of FIG. 12.

Transceiver 4995 may include one or more radios capable of transmitting and receiving signals using various suitable wireless communications techniques, and may be the same as or similar to transceiver 995b in FIG. 12.

Display 4980 may include any television type monitor or display, and may be the same as or similar to display 380, and/or to display 980 in FIG. 12.

Storage 4962 may be implemented as a non-volatile storage device, and may be the same as or similar to non-volatile storage 962 in FIG. 12.

Graphics subsystem 4985 may perform processing of images such as still or video for display. Graphics subsystem 4985 may be a graphics processing unit (GPU) or a visual processing unit (VPU), for example. An analog or digital interface may be used to communicatively couple graphics subsystem 4985 and display 4980. For example, the interface may be any of a High-Definition Multimedia Interface, DisplayPort, wireless HDMI, and/or wireless HD compliant techniques. Graphics subsystem 4985 could be integrated into processor circuit 4950 or chipset 4955. Graphics subsystem 4985 could be a stand-alone card communicatively coupled to chipset 4955.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

In embodiments, content services device(s) 4900b may be hosted by any national, international and/or independent service and thus accessible to platform 4900a via the Internet, for example. Content services device(s) 4900b may be coupled to platform 4900a and/or to display 4980. Platform 4900a and/or content services device(s) 4900b may be coupled to a network 4999 to communicate (e.g., send and/or receive) media information to and from network 4999. Content delivery device(s) 4900c also may be coupled to platform 4900a and/or to display 4980.

In embodiments, content services device(s) 4900b may include a cable television box, personal computer, network, telephone, Internet enabled devices or appliance capable of delivering digital information and/or content, and any other similar device capable of unidirectionally or bidirectionally communicating content between content providers and platform 4900a and/display 4980, via network 4999 or directly. It will be appreciated that the content may be communicated unidirectionally and/or bidirectionally to and from any one of the components in system 4000 and a content provider via network 4999. Examples of content may include any media information including, for example, video, music, medical and gaming information, and so forth.

Content services device(s) 4900b receives content such as cable television programming including media information, digital information, and/or other content. Examples of content providers may include any cable or satellite television or radio or Internet content providers. The provided examples are not meant to limit embodiments.

In embodiments, platform 4900a may receive control signals from navigation controller 4920 having one or more navigation features. The navigation features of navigation controller 4920 may be used to interact with a user interface 4880, for example. In embodiments, navigation controller 4920 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of navigation controller 4920 may be echoed on a display (e.g., display 4980) by movements of a pointer, cursor, focus ring, or other visual indicators displayed on the display. For example, under the control of software applications 4940, the navigation features located on navigation controller 4920 may be mapped to virtual navigation features displayed on user interface 4880. In embodiments, navigation controller 4920 may not be a separate component but integrated into platform 4900a and/or display 4980. Embodiments, however, are not limited to the elements or in the context shown or described herein.

In embodiments, drivers (not shown) may include technology to enable users to instantly turn on and off platform 4900a like a television with the touch of a button after initial boot-up, when enabled, for example. Program logic may allow platform 4900a to stream content to media adaptors or other content services device(s) 4900b or content delivery device(s) 4900c when the platform is turned “off.” In addition, chip set 4955 may include hardware and/or software support for 5.1 surround sound audio and/or high definition 7.1 surround sound audio, for example. Drivers may include a graphics driver for integrated graphics platforms. In embodiments, the graphics driver may include a peripheral component interconnect (PCI) Express graphics card.

In various embodiments, any one or more of the components shown in system 4000 may be integrated. For example, platform 4900a and content services device(s) 4900b may be integrated, or platform 4900a and content delivery device(s) 4900c may be integrated, or platform 4900a, content services device(s) 4900b, and content delivery device(s) 4900c may be integrated, for example. In various embodiments, platform 4900a and display 4890 may be an integrated unit. Display 4980 and content service device(s) 4900b may be integrated, or display 4980 and content delivery device(s) 4900c may be integrated, for example. These examples are not meant to limit embodiments.

In various embodiments, system 4000 may be implemented as a wireless system, a wired system, or a combination of both. When implemented as a wireless system, system 4000 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 4000 may include components and interfaces suitable for communicating over wired communications media, such as I/O adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 4900a may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 13.

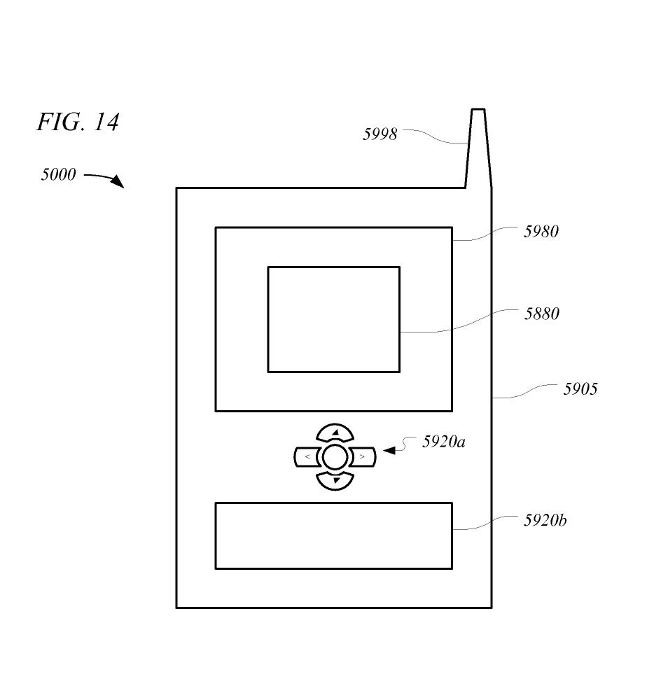

As described above, system 4000 may be embodied in varying physical styles or form factors. FIG. 14 illustrates embodiments of a small form factor device 5000 in which system 4000 may be embodied. In embodiments, for example, device 5000 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 14, device 5000 may include a display 5980, a navigation controller 5920a, a user interface 5880, a housing 5905, an I/O device 5920b, and an antenna 5998. Display 5980 may include any suitable display unit for displaying information appropriate for a mobile computing device, and may be the same as or similar to display 4980 in FIG. 13. Navigation controller 5920a may include one or more navigation features which may be used to interact with user interface 5880, and may be the same as or similar to navigation controller 4920 in FIG. 13. I/O device 5920b may include any suitable I/O device for entering information into a mobile computing device. Examples for I/O device 5920b may include an alphanumeric keyboard, a numeric keypad, a touch pad, input keys, buttons, switches, rocker switches, microphones, speakers, voice recognition device and software, and so forth. Information also may be entered into device 5000 by way of a microphone. Such information may be digitized by a voice recognition device. The embodiments are not limited in this context.

More generally, the various elements of the computing devices described and depicted herein may include various hardware elements, software elements, or a combination of both. Examples of hardware elements may include devices, logic devices, components, processors, microprocessors, circuits, processor components, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other. Furthermore, aspects or elements from different embodiments may be combined.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. The detailed disclosure now turns to providing examples that pertain to further embodiments. The examples provided below are not intended to be limiting.

An example of a device to coordinate parallel video transcoding includes a processor component, and a monitoring component for execution by the processor component to determine whether a total current bitrate remains within a target range of bitrates to transcode multiple segments of an original video data using multiple slave devices in parallel to generate a transcoded video data, the total current bitrate derived from a sum of current bitrates of video compression performed by the multiple slave devices in transcoding the multiple segments.

The above example of a device in which the device includes an adjustment component for execution by the processor component to signal a slave device of the multiple slave devices to enter a panic mode to alter a current bitrate of video compression performed by the slave device in transcoding a segment of the multiple segments in response to the total current bitrate not remaining within the target range.

Either of the above examples of a device in which the panic mode is to cause the slave device to substitute use of a main quantization parameter with use of an alternate quantization parameter in video compression.

Any of the above examples of a device in which the device includes an analysis component for execution by the processor component to provide the main quantization parameter and the alternate quantization parameter to the slave device prior to the slave device transcoding the segment.

Any of the above examples of a device in which the analysis component is to derive one of the main quantization parameter and the alternate quantization parameter from an analysis of at least the segment.

Any of the above examples of a device in which the monitoring component is to determine whether the total current bitrate diverges from a specified target bitrate to transcode the multiple segments, and the adjustment component to signal a slave device of the multiple slave devices with an adjusted value for a main quantization parameter to dynamically alter a current bitrate of video compression performed by the slave device in transcoding a segment of the multiple segments in response to the total current bitrate diverging from the specified target bitrate.

Any of the above examples of a device in which the device includes a splitting component to divide the original video data into the multiple segments and to provide each segment of the multiple segments to a slave device of the multiple slave devices.

Any of the above examples of a device in which the device includes an assembly component to combine multiple segments of the transcoded video data received from the multiple slave devices following transcoding of the multiple segments of the original video data by the multiple slave devices to generate the transcoded video data.

Any of the above examples of a device in which the device includes a display, the processor component to visually present the transcoded video data on the display.

An example of another device to coordinate parallel video transcoding includes a processor component, and a monitoring component for execution by the processor component to determine whether a total current bitrate diverges from a specified target bitrate to transcode multiple segments of an original video data using multiple slave devices in parallel to generate a transcoded video data, the total current bitrate derived from a sum of current bitrates of video compression performed by the multiple slave devices in transcoding the multiple segments.

The above example of another device in which the device includes an adjustment component to signal a slave device of the multiple slave devices with an adjusted value for a main quantization parameter to dynamically alter a current bitrate of video compression performed by the slave device in transcoding a segment of the multiple segments in response to the total current bitrate diverging from the specified target bitrate.

Either of the above examples of another device in which the device includes an analysis component for execution by the processor component to provide the main quantization parameter to the slave device prior to the slave device transcoding the segment.

Any of the above examples of another device in which the analysis component is to derive the main quantization parameter from an analysis of at least the segment.

Any of the above examples of another device in which the monitoring component is to determine whether the total current bitrate remains within a target range of bitrates to transcode the multiple segments, and the adjustment component to signal a slave device of the multiple slave devices to enter a panic mode to alter a current bitrate of video compression performed by the slave device in transcoding a segment of the multiple segments in response to the total current bitrate not remaining within the target bitrate.

Any of the above examples of another device in which the device includes a splitting component to divide the original video data into the multiple segments and to provide each segment of the multiple segments to a slave device of the multiple slave devices.

Any of the above examples of another device in which the device includes an assembly component to combine multiple segments of the transcoded video data received from the multiple slave devices following transcoding of the multiple segments of the original video data by the multiple slave devices to generate the transcoded video data.

Any of the above examples of another device in which the device includes a display, the processor component to visually present the transcoded video data on the display.

Any of the above examples of another device in which the device includes an interface to couple the processor component to a network, and a communications component for execution by the processor component to transmit the transcoded video data to a computing device via the network.

An example of a computer-implemented method for coordinating parallel video transcoding includes deriving a total current bitrate from a sum of current bitrates of video compression performed by multiple slave devices in transcoding multiple segments of an original video data, and determining whether the total current bitrate remains within a target range of bitrates to transcode the multiple segments using the multiple slave devices in parallel to generate a transcoded video data.

The above example of a computer-implemented method in which the method includes signaling a slave device of the multiple slave devices to enter a panic mode to alter a current bitrate of video compression performed by the slave device in transcoding a segment of the multiple segments in response to the total current bitrate not remaining within the target range.

Either of the above examples of a computer-implemented method in which the panic mode is to cause the slave device to substitute use of a main quantization parameter with use of an alternate quantization parameter in video compression.

Any of the above examples of a computer-implemented method in which the method includes signaling the slave device with the main quantization parameter and the alternate quantization parameter prior to the slave device transcoding the segment.

Any of the above examples of a computer-implemented method in which the method includes signaling the slave device to enter the panic mode by transmitting a first packet via a network to the slave device, and signaling the slave device with the main quantization parameter and the alternate quantization parameter by transmitting a second packet via the network to the slave device, the second packet larger than the first packet and comprising a data payload comprising indications of values for the main quantization parameter and the alternate quantization parameter.

Any of the above examples of a computer-implemented method in which the method includes deriving one of the main quantization parameter and the alternate quantization parameter from an analysis of at least the segment.

Any of the above examples of a computer-implemented method in which the method includes determining whether the total current bitrate diverges from a specified target bitrate to transcode the multiple segments, and signaling a slave device of the multiple slave devices with an adjusted value for a main quantization parameter to dynamically alter a current bitrate of video compression performed by the slave device in transcoding a segment of the multiple segments in response to the total current bitrate diverging from the specified target bitrate.

Any of the above examples of a computer-implemented method in which the method includes dividing the original video data into the multiple segments, and providing each segment of the multiple segments to a slave device of the multiple slave devices.

Any of the above examples of a computer-implemented method in which the method includes combining multiple segments of the transcoded video data received from the multiple slave devices following transcoding of the multiple segments of the original video data by the multiple slave devices to generate the transcoded video data.

Any of the above examples of a computer-implemented method in which the method includes one of visually presenting the transcoded video data on a display or transmitting the transcoded video data to a computing device.

An example of an apparatus for coordinating parallel video transcoding includes means for performing any of the above examples of a computer-implemented method.

An example of at least one machine readable storage medium includes instructions that when executed by a computing device, causes the computing device to perform any of the above examples of a computer-implemented method.

An example of another computer-implemented method for coordinating parallel video transcoding includes deriving a total current bitrate from a sum of current bitrates of video compression performed by multiple slave devices in transcoding multiple segments of an original video data, and determining whether the total current bitrate diverges from a specified target bitrate to transcode the multiple segments using the multiple slave devices in parallel to generate a transcoded video data.

The above example of another computer-implemented method in which the method includes signaling a slave device of the multiple slave devices with an adjusted value for a main quantization parameter to dynamically alter a current bitrate of video compression performed by the slave device in transcoding a segment of the multiple segments in response to the total current bitrate diverging from the specified target bitrate.

Either of the above examples of another computer-implemented method in which the method includes providing the main quantization parameter to the slave device prior to the slave device transcoding the segment.

Any of the above examples of another computer-implemented method in which the method includes deriving the main quantization parameter from an analysis of at least the segment.

Any of the above examples of another computer-implemented method in which the method includes determining whether the total current bitrate remains within a target range of bitrates to transcode the multiple segments, and signaling a slave device of the multiple slave devices to enter a panic mode to alter a current bitrate of video compression performed by the slave device in transcoding a segment of the multiple segments in response to the total current bitrate not remaining within the target range.

Any of the above examples of another computer-implemented method in which the method includes dividing the original video data into the multiple segments, and providing each segment of the multiple segments to a slave device of the multiple slave devices.

Any of the above examples of another computer-implemented method in which the method includes combining multiple segments of the transcoded video data received from the multiple slave devices following transcoding of the multiple segments of the original video data by the multiple slave devices to generate the transcoded video data.

Any of the above examples of another computer-implemented method in which the method includes one of visually presenting the transcoded video data on a display or transmitting the transcoded video data to a computing device.

An example of another apparatus for coordinating parallel video transcoding includes means for performing any of the above examples of another computer-implemented method.

Another example of at least one machine readable storage medium includes instructions that when executed by a computing device, causes the computing device to perform any of the above examples of another computer-implemented method.

An example of at least one machine-readable storage medium includes instructions that when executed by a computing device, cause the computing device to determine whether a total current bitrate remains within a target range of bitrates to transcode multiple segments of an original video data using multiple slave devices in parallel to generate a transcoded video data, the total current bitrate derived from a sum of current bitrates of video compression performed by the multiple slave devices in transcoding the multiple segments.

The above example of at least one machine-readable storage medium in which the computing device is caused to signal a slave device of the multiple slave devices to enter a panic mode to alter a current bitrate of video compression performed by the slave device in transcoding a segment of the multiple segments in response to the total current bitrate not remaining within the target range.

Either of the above examples of at least one machine-readable storage medium in which the panic mode is to cause the slave device to substitute use of a main quantization parameter with use of an alternate quantization parameter in video compression.

Any of the above examples of at least one machine-readable storage medium in which the computing device is caused to determine whether the total current bitrate diverges from a specified target bitrate to transcode the multiple segments, and signal a slave device of the multiple slave devices with an adjusted value for a main quantization parameter to dynamically alter a current bitrate of video compression performed by the slave device in transcoding a segment of the multiple segments in response to the total current bitrate diverging from the specified target bitrate.

Any of the above examples of at least one machine-readable storage medium in which the computing device is caused to either visually present the transcoded video data on a display or transmit the transcoded video data to another computing device.

Another example of at least one machine-readable storage medium includes instructions that when executed by a computing device, cause the computing device to determine whether a total current bitrate diverges from a specified target bitrate to transcode multiple segments of an original video data using multiple slave devices in parallel to generate a transcoded video data, the total current bitrate derived from a sum of current bitrates of video compression performed by the multiple slave devices in transcoding the multiple segments.

The above other example of at least one machine-readable storage medium in which the computing device is caused to signal a slave device of the multiple slave devices with an adjusted value for a main quantization parameter to dynamically alter a current bitrate of video compression performed by the slave device in transcoding a segment of the multiple segments in response to the total current bitrate diverging from the specified target bitrate.

Either of the above other examples of at least one machine-readable storage medium in which the computing device is caused to determine whether the total current bitrate remains within a target range of bitrates to transcode the multiple segments, and signal a slave device of the multiple slave devices to enter a panic mode to alter a current bitrate of video compression performed by the slave device in transcoding a segment of the multiple segments in response to the total current bitrate not remaining within the target range.

Any of the above other examples of at least one machine-readable storage medium in which the computing device is caused to either visually present the transcoded video data on a display or transmit the transcoded video data to another computing device.

1. A device to coordinate parallel video transcoding comprising:
a processor component; and
a monitoring component for execution by the processor component to determine whether a total current bitrate remains within a target range of bitrates to transcode multiple segments of an original video data using multiple slave devices in parallel to generate a transcoded video data, the total current bitrate derived from a sum of current bitrates of video compression performed by the multiple slave devices in transcoding the multiple segments.

2. The device of claim 1, comprising an adjustment component for execution by the processor component to signal a slave device of the multiple slave devices to enter a panic mode to alter a current bitrate of video compression performed by the slave device in transcoding a segment of the multiple segments in response to the total current bitrate not remaining within the target range.

3. The device of claim 2, the panic mode to cause the slave device to substitute use of a main quantization parameter with use of an alternate quantization parameter in video compression.

4. The device of claim 3, comprising an analysis component for execution by the processor component to provide the main quantization parameter and the alternate quantization parameter to the slave device prior to the slave device transcoding the segment.

5. The device of claim 4, the analysis component to derive one of the main quantization parameter and the alternate quantization parameter from an analysis of at least the segment.

6. The device of claim 1, the monitoring component to determine whether the total current bitrate diverges from a specified target bitrate to transcode the multiple segments, and the adjustment component to signal a slave device of the multiple slave devices with an adjusted value for a main quantization parameter to dynamically alter a current bitrate of video compression performed by the slave device in transcoding a segment of the multiple segments in response to the total current bitrate diverging from the specified target bitrate.

7. The device of claim 1, comprising a display, the processor component to visually present the transcoded video data on the display.

8. A device to coordinate parallel video transcoding comprising:
a processor component; and
a monitoring component for execution by the processor component to determine whether a total current bitrate diverges from a specified target bitrate to transcode multiple segments of an original video data using multiple slave devices in parallel to generate a transcoded video data, the total current bitrate derived from a sum of current bitrates of video compression performed by the multiple slave devices in transcoding the multiple segments.

9. The device of claim 8, comprising an adjustment component to signal a slave device of the multiple slave devices with an adjusted value for a main quantization parameter to dynamically alter a current bitrate of video compression performed by the slave device in transcoding a segment of the multiple segments in response to the total current bitrate diverging from the specified target bitrate.

10. The device of claim 8, the monitoring component to determine whether the total current bitrate remains within a target range of bitrates to transcode the multiple segments, and the adjustment component to signal a slave device of the multiple slave devices to enter a panic mode to alter a current bitrate of video compression performed by the slave device in transcoding a segment of the multiple segments in response to the total current bitrate not remaining within the target bitrate.

11. The device of claim 8, comprising a splitting component to divide the original video data into the multiple segments and to provide each segment of the multiple segments to a slave device of the multiple slave devices.

12. The device of claim 11, comprising an assembly component to combine multiple segments of the transcoded video data received from the multiple slave devices following transcoding of the multiple segments of the original video data by the multiple slave devices to generate the transcoded video data.

13. The device of claim 8, comprising a display, the processor component to visually present the transcoded video data on the display.

14. A computing-implemented method for coordinating parallel video transcoding comprising:
deriving a total current bitrate from a sum of current bitrates of video compression performed by multiple slave devices in transcoding multiple segments of an original video data; and
determining whether the total current bitrate remains within a target range of bitrates to transcode the multiple segments using the multiple slave devices in parallel to generate a transcoded video data.

15. The computer-implemented method of claim 14, comprising signaling a slave device of the multiple slave devices to enter a panic mode to alter a current bitrate of video compression performed by the slave device in transcoding a segment of the multiple segments in response to the total current bitrate not remaining within the target range.

16. The computer-implemented method of claim 15, the panic mode to cause the slave device to substitute use of a main quantization parameter with use of an alternate quantization parameter in video compression.

17. The computer-implemented method of claim 14, comprising:
determining whether the total current bitrate diverges from a specified target bitrate to transcode the multiple segments; and
signaling a slave device of the multiple slave devices with an adjusted value for a main quantization parameter to dynamically alter a current bitrate of video compression performed by the slave device in transcoding a segment of the multiple segments in response to the total current bitrate diverging from the specified target bitrate.

18. The computer-implemented method of claim 14, comprising:
dividing the original video data into the multiple segments; and
providing each segment of the multiple segments to a slave device of the multiple slave devices.

19. The computer-implemented method of claim 18, comprising combining multiple segments of the transcoded video data received from the multiple slave devices following transcoding of the multiple segments of the original video data by the multiple slave devices to generate the transcoded video data.

20. The computer-implemented method of claim 14, comprising one of visually presenting the transcoded video data on a display or transmitting the transcoded video data to a computing device.

21. At least one machine-readable storage medium comprising instructions that when executed by a computing device, cause the computing device to:
determine whether a total current bitrate remains within a target range of bitrates to transcode multiple segments of an original video data using multiple slave devices in parallel to generate a transcoded video data, the total current bitrate derived from a sum of current bitrates of video compression performed by the multiple slave devices in transcoding the multiple segments.

22. The at least one machine-readable storage medium of claim 21, the computing device caused to signal a slave device of the multiple slave devices to enter a panic mode to alter a current bitrate of video compression performed by the slave device in transcoding a segment of the multiple segments in response to the total current bitrate not remaining within the target range.

23. The at least one machine-readable storage medium of claim 22, the panic mode to cause the slave device to substitute use of a main quantization parameter with use of an alternate quantization parameter in video compression.

24. The at least one machine-readable storage medium of claim 21, the computing device caused to:
determine whether the total current bitrate diverges from a specified target bitrate to transcode the multiple segments; and
signal a slave device of the multiple slave devices with an adjusted value for a main quantization parameter to dynamically alter a current bitrate of video compression performed by the slave device in transcoding a segment of the multiple segments in response to the total current bitrate diverging from the specified target bitrate.

25. The at least one machine-readable storage medium of claim 21, the computing device caused to either visually present the transcoded video data on a display or transmit the transcoded video data to another computing device.
